(19) United States
(12) Patent Application Publication
(10) Pub. No.: US 2025/0150360 A1
(43) Pub. Date: May 8, 2025

(54) CLOUD BASED AND X-CENTRIC NETWORK IMPLEMENTATION ARCHITECTURE

(71) Applicant: HUAWEI TECHNOLOGIES CO., LTD., SHENZHEN (CN)

(72) Inventor: Hang ZHANG, Kanata (CA)

(73) Assignee: HUAWEI TECHNOLOGIES CO., LTD., SHENZHEN (CN)

(21) Appl. No.: 19/015,136

(22) Filed: Jan. 9, 2025

Related U.S. Application Data
(63) Continuation of application No. PCT/CN2023/091334, filed on Apr. 27, 2023.
(60) Provisional application No. 63/402,309, filed on Aug. 30, 2022.

(51) Int. Cl. H04L 41/40; H04L 41/5051

(52) U.S. Cl. CPC H04L 41/40; H04L 41/5051

(57) ABSTRACT

A method, apparatus and system providing an open system architecture, referred to as X-centric architecture, that offers, supports or enables anything-as-a-service (XaaS) and can be centric to a variety of roles to support various operation scenarios. A cloud-based implementation of the X-centric network architecture is provided.

### CROSS-REFERENCE TO RELATED APPLICATIONS

This application is a continuation of International Patent Application No. PCT/CN2023/091334, filed on Apr. 27, 2023, which claims the benefit of the prior-filed provisional patent application in the United States, with Application No. 63/402,309 filed on Aug. 30, 2022 and titled “CLOUD BASED AND X-CENTRIC NETWORK IMPLEMENTATION ARCHITECTURE”, the contents of both of which are incorporated herein by reference in their entirety.

### TECHNICAL FIELD

This invention pertains generally to the field of computerized communication systems and in particular to communication infrastructures for implementing anything-as-a-service (XaaS) service delivery.

### BACKGROUND

Current wireless communication systems (also referred to as wireless systems), such as 5^{th} Generation (5G) systems as defined by the 3^{rd} Generation Partnership Project (3GPP) are designed to provide connectivity services only. It is anticipated that future wireless systems (e.g. 6^{th} Generation (6G) systems as defined by the 3GPP) will go beyond connectivity provisioning to offer various new services. It is also anticipated the future wireless system may be operated by multiple parties, for example with different parties operating a different portion of the wireless system to offer certain services. These services may be provided for the system's (e.g. operating party's) internal use or for an end customer's use.

Cloud-based technologies allow resources to be pooled using virtualization technologies and shared across a network. It is anticipated that cloud-based technologies will be an important aspect of future networks, in addition to traditional network deployed cellular network infrastructure. New services, such as artificial intelligence or data services, for example as provided by third parties, may be broadly applied, and cloud-based technologies and multiple service enabled network implementation architectures are expected to become more important to support such services.

However, current wireless systems and infrastructure require further development to support the above scenario and comparable scenarios. Such development is not straightforward and can require solving of a variety of technical and design problems.

Therefore, there is a need for a method, apparatus and system for network implementations, that obviates or mitigates one or more limitations in the prior art.

This background information is intended to provide information that may be of possible relevance to the present disclosure. No admission is necessarily intended, nor should be construed, that any of the preceding information constitutes prior art against the present disclosure.

### SUMMARY

Embodiments of the present disclosure provide for a cloud-based network implementation. Embodiments can further relate to an open system architecture for wireless systems that offers anything-as-a-service (XaaS) functionality. Embodiments can be centric to any one of a variety of roles to support various operation scenarios, a feature that is referred to herein as being an X-centric architecture. Furthermore, embodiments can be provided as an open system architecture. Embodiments may be extensible, allowing unknown future services to be dynamically enabled or offered, substantially without the need to modify or redesign the system architecture. To facilitate this, the X-centric architecture can be provided using a modular design, as described herein. A service supported by the X-centric architecture can be referred to as an XaaS service. The modular design may allow a new service module to be added dynamically to enable or offer or support an associated new XaaS service.

In accordance with an embodiment of the present disclosure, there is provided a system for example formed at least in part from multiple networked computing devices of a networked communication system, each having at least a processor, a network interface, and a memory. The system includes one or more infrastructure modules each providing a respective infrastructure resource as service. The system includes one or more service modules each providing a respective functionality as service and utilizing at least one of the infrastructure resources as service. Each infrastructure resource may include a respective type of device for supporting the networked communication system. The system includes one or more control and management (C/M) modules each providing a respective management or control resource as service, at least one of the control and management modules providing said respective management or control resource (also referred to as function) as service to at least one of the infrastructure modules or the service modules. The system may further include one or more gateways providing a secured connection with, and facilitating interaction between, some or all of the infrastructure modules, the service modules and the control and management modules. Some or all of the infrastructure modules, the service modules, the control and management modules and the gateways may be implemented using virtualized resources provided by one or a plurality of clouds.

In some embodiments, the system includes a C/M plane interface gateway (GW) or trustworthy gateway (TW-GW) configured as an intermediary for interconnecting some of all of the infrastructure modules, the service modules and the control and management modules residing in a same one of the clouds. The interconnection may include interconnection of control and management functions of the modules. In some further embodiments, some or all of the infrastructure modules, the service modules and the control and management modules are implemented in a plurality of clouds. In such embodiments the system further includes, in each one of the plurality of clouds, a different respective one of the C/M plane interface gateways (GWs) or trustworthy gateways (TW-GWs). Different respective ones of the C/M plane interface gateways (GWs) or trustworthy gateways (TW-GWs) are coupled together for interconnecting different ones of the infrastructure modules, the service modules and the control and management modules residing in different ones of the clouds. In other further embodiments, the C/M plane interface gateway (GW) or trustworthy gateway (TW-GW) is configured to operate as a signal message forwarding function (with or without translation) in order to facilitate an interface between one or more pairs of modules, each pair of modules selected from the one or more infrastructure modules, the one or more service modules, and the one or more control and management modules, the interface being a direct logical interface. In other further embodiments, the C/M plane interface gateway (GW) or trustworthy gateway (TW-GW) is configured to operate as a signal message translator in order to facilitate an interface between one or more pairs of modules, each pair of modules selected from the one or more infrastructure modules, the one or more service modules, and the one or more control and management modules. The signal message translator may change content of messages being forwarded between said one or more pairs of modules.

In some embodiments, the C/M plane interface gateway (GW) or trustworthy gateway (TW-GW) is further configured to communicatively couple some of all of the infrastructure modules, the service modules and the control and management modules to a C/M plane connection, the C/M plane connection operative for control plane messaging between client devices, servers, and some or all of the infrastructure modules, the service modules and the control and management modules.

In some embodiments, the C/M plane interface GW or TW-GW is configured to control access to one or more of the infrastructure modules, the service modules and the control and management modules, the attempted access being by one or more other of infrastructure modules, the service modules and the control and management modules or by another device. In some embodiments, the C/M plane interface gateway (GW) or trustworthy gateway (TW-GW) is configured to: receive a request for a first module of the infrastructure modules, the service modules and the control and management modules to use a specified service; determine a second module of the infrastructure modules, the service modules and the control and management modules, the second module providing the specified service and the first module being authorized to receive the specified service from the second module; and forward the request to the second module.

In some embodiments, the system further includes a data plane interface gateway (GW) or trustworthy gateway (TW-GW) configured as an intermediary for interconnecting some or all of the service modules to a data plane connection, the data plane connection operative for data transmission between client devices, servers, and some or all of the infrastructure modules, the service modules and the control and management modules. The data plane interface GW or TW-GW may interconnect data processing functions of the modules. In some further embodiments, the aforementioned some or all of the service modules are implemented in a plurality of clouds, the system further comprising, in each one of the plurality of clouds, a different respective one of the data plane interface gateways (GWs) or trustworthy gateways (TW-GWs). Different respective ones of the data plane interface gateways (GWs) or trustworthy gateways (TW-GWs) are coupled together for interconnecting different ones of the service modules residing in different ones of the clouds. In some further embodiments, one or more of the different respective ones of the data plane interface gateways (GWs) or trustworthy gateways (TW-GWs) are operative to provide a 6G data plane interconnecting one or more of the service modules with one or more client devices, said interconnecting using the data plane connection. In some further embodiments, the 6G data plane is instantiated in support of a mission involving said interconnected one or more of the service modules. The mission may require joint contribution form one or multiple service modules. In some further embodiments, the data plane interface GW or TW-GW is configured to control access to one or more of the infrastructure modules, the service modules and the control and management modules, the attempted access being by one or more other of infrastructure modules, the service modules and the control and management modules or by another device.

In some embodiments, the infrastructure modules, the service modules and the control and management modules comprise a first group of modules implemented using virtualized resources provided by a first cloud and a second group of modules implemented using virtualized resources provided by a second cloud, and the first group of modules are organized and interconnected in a same manner as the second group of modules.

In some embodiments, the system further includes a C/M plane interface GW or TW-GW and a data plane interface GW or TW-GW. The C/M plane interface GW or TW-GW is configured as an intermediary for interconnecting, via dedicated and secured connections, the infrastructure modules, the service modules and the control and management modules residing in a same one of the clouds. The data plane interface GW or TW-GW is configured as another intermediary for interconnecting, via further dedicated and secured connections, some or all of the infrastructure modules, the service modules and the control and management modules to a data plane connection. The data plane connection is operative for data transmission between client devices, servers, and some or all of the infrastructure modules, the service modules and the control and management modules. The infrastructure modules, the service modules and the control and management modules, the C/M plane interface GW or TW-GW, and the data plane interface GW or TW-GW collectively form some or all of a basic architecture structure (BAS). In some further embodiments, the system further includes one or more additional BASs having a same structure as the BAS, the BAS and the additional BASs being interconnected. In some further embodiments, the same one of the clouds and its physical infrastructure forms some or all of a BAS domain. In some further embodiments, the system further includes another C/M plane interface gateway (GW) or trustworthy gateway (TW-GW) forming part of another BAS and connected to the C/M plane interface GW or TW-GW of the BAS; and another data plane interface GW or TW-GW forming part of said other BAS and connected to the data plane interface GW or TW-GW of the BAS.

In some embodiments, the system serves at least one device implemented at least in part using virtualized resources provided by said one or the plurality of clouds, or provided by a further cloud. Additionally or alternatively, the device may be configured to include: one or more further infrastructure modules each providing a respective infrastructure resource as service; one or more further service modules each providing a respective functionality as service and utilizing at least one of the infrastructure resources as service; and one or more further control and management modules each providing a respective further management or control resource as service, at least one of the further control and management modules providing said respective further management or control resource as service to at least one of the further infrastructure modules or the further service modules

In accordance with an embodiment of the present disclosure, there is provided a method, for example performed by one or a collection of networked computing devices. The method includes providing one or more infrastructure resources as service, using one or more respective infrastructure modules; providing one or more functionalities as service, using one or more respective service modules, at least one service module utilizing at least one of the infrastructure resources as service; and providing one or more management or control resources as service using one or more respective control and management modules, at least one of the control and management modules providing said respective management or control resource as service to at least one of the infrastructure modules or the service modules. The method may further include providing one or more gateways providing a secured connection with, and facilitating interaction between, some or all of the infrastructure modules, the service modules and the control and management modules. Some or all of the infrastructure modules, the service modules and the control and management modules may be implemented using virtualized resources provided by one or a plurality of clouds. Other aspects of the method are similar to aspects of the system as already described above.

For example, the method may include providing, as one or more of the gateways, a C/M plane interface gateway (GW) or trustworthy gateway (TW-GW) configured as an intermediary for interconnecting (e.g. control and management functions of) some of all of the infrastructure modules, the service modules and the control and management modules residing in a same one of the clouds. The method may include implementing said some or all of the infrastructure modules, the service modules and the control and management modules in a plurality of clouds, the method further comprising providing, in each one of the plurality of clouds, a different respective one of the C/M plane interface gateways (GWs) or trustworthy gateways (TW-GWs), wherein different respective ones of the C/M plane interface gateways (GWs) or trustworthy gateways (TW-GWs) are coupled together for interconnecting different ones of the infrastructure modules, the service modules and the control and management modules residing in different ones of the clouds. The method may include configuring the C/M plane interface gateway (GW) or trustworthy gateway (TW-GW) to operate as a signal message forwarding function in order to facilitate an interface between one or more pairs of modules, each pair of modules selected from the one or more infrastructure modules, the one or more service modules, and the one or more control and management modules, the interface being a direct logical interface. The method may include configuring the C/M plane interface gateway (GW) or trustworthy gateway (TW-GW) to operate as a signal message translator in order to facilitate an interface between one or more pairs of modules, each pair of modules selected from the one or more infrastructure modules, the one or more service modules, and the one or more control and management modules. The method may include configuring the C/M plane interface gateway (GW) or trustworthy gateway (TW-GW) to communicatively couple some of all of the infrastructure modules, the service modules and the control and management modules to a C/M plane connection, the C/M plane connection operative for control plane messaging between client devices, servers, and some or all of the infrastructure modules, the service modules and the control and management modules. The method may include providing a data plane interface gateway (GW) or trustworthy gateway (TW-GW) configured as an intermediary for interconnecting (e.g. data processing functions of) some or all of the service modules to a data plane connection, the data plane connection operative for data transmission between client devices, servers, and some or all of the infrastructure modules, the service modules and the control and management modules. The method may include implementing said some or all of the service modules in a plurality of clouds, and providing, in each one of the plurality of clouds, a different respective one of the data plane interface gateways (GWs) or trustworthy gateways (TW-GWs), wherein different respective ones of the data plane interface gateways (GWs) or trustworthy gateways (TW-GWs) are coupled together for interconnecting different ones of the service modules residing in different ones of the clouds. In some embodiments, one or more of the different respective ones of the data plane interface gateways (GWs) or trustworthy gateways (TW-GWs) are operative to provide a 6G data plane interconnecting one or more of the service modules with one or more client devices, said interconnecting using the data plane connection. In some embodiments, the 6G data plane is instantiated in support of a mission involving said interconnected one or more of the service modules. In some embodiments, the infrastructure modules, the service modules and the control and management modules comprise a first group of modules implemented using virtualized resources provided by a first cloud and a second group of modules implemented using virtualized resources provided by a second cloud, and wherein the first group of modules are organized and interconnected in a same manner as the second group of modules. The method may include serving at least one device implemented at least in part using virtualized resources provided by said one or the plurality of clouds, or provided by a further cloud.

In accordance with an embodiment of the present disclosure, there is provided a computer program product comprising a (e.g. non-transitory) computer readable medium having statements and instructions stored thereon which, when executed by one or more computer processors, cause the computer processors to perform the method as set forth above.

### BRIEF DESCRIPTION OF THE DRAWINGS

Further features and advantages of the present invention will become apparent from the following detailed description, taken in combination with the appended drawings, in which:

FIG. 1A illustrates a system including service modules, control and management modules and infrastructure modules, in accordance with embodiments of the present disclosure.

FIG. 1B illustrates a system including service modules, control and management modules and infrastructure modules, in accordance with other embodiments of the present disclosure.

FIG. 2 illustrates a system including service modules, control and management modules and infrastructure modules, and contents and interconnections of such modules, in accordance with embodiments of the present disclosure.

FIG. 3 illustrates a 3GPP 5G network implementation architecture, according to the prior art.

FIGS. 4A to 4C illustrate a cloud based X-centric network system, in accordance with embodiments of the present disclosure.

FIG. 4D illustrates a unified Basic Architecture Structure (BAS) according to an embodiment of the present disclosure.

FIG. 4E illustrates a relationship between a system BAS and an XaaS BAS in a Service Layer, according to an embodiment of the present disclosure.

FIG. 4F illustrates a relationship between a system BAS and an XaaS BAS in a C/M Layer, according to an embodiment of the present disclosure.

FIG. 4G illustrates interconnection between BASs, according to an embodiment of the present disclosure.

FIG. 4H illustrates multiple interconnected BASs in different clouds, according to an embodiment of the present disclosure.

FIG. 4I illustrates an X-centric network architecture according to an embodiment of the present disclosure.

FIG. 5A illustrates a communication system including interconnected BASs and supporting backward compatibility, according to an embodiment of the present disclosure.

FIG. 5B illustrates a communication system including interconnected BASs, according to another embodiment of the present disclosure.

FIG. 5C illustrates a communication system including interconnected BASs, according to another embodiment of the present disclosure.

FIGS. 6A to 6C illustrate the system of FIGS. 4A to 4C, with the addition of a 6G data plane, in accordance with embodiments of the present disclosure.

FIG. 6D is another representation of FIGS. 6A to 6C.

FIG. 7A illustrates C/M plane interfaces for a service based interface (SBI), according to an embodiment of the present disclosure.

FIG. 7B illustrates C/M plane interfaces for a service based interface (SBI), according to another embodiment of the present disclosure.

FIG. 8 illustrates a computing device that may perform computing or related operations according to embodiments of the present disclosure.

It will be noted that throughout the appended drawings, like features are identified by like reference numerals.

### DETAILED DESCRIPTION

As used herein, the term “anything-as-a-service,” i.e. “XaaS” can reflect the concept as it has been proposed in the computer networking industry. For example, XaaS can be conceptualized as a generalization of software-as-a-service or infrastructure-as-a-service concepts. XaaS can leverage cloud computing and device virtualization concepts, coupled with a service model to deliver a variety of functionalities. According to embodiments of the present disclosure, XaaS can describe for example that the functionality of an arbitrary module disclosed herein can be provided as a service to another module or an external entity, such as a customer. The phrase “as service” is used herein to be synonymous with “as a service.”

An open system architecture may refer to a design approach in which systems (e.g. modules) are interoperable and interconnectable with one another, generally without requiring retrofit or redesign. An open system architecture is one approach for achieving a modular design in which modules are configured to be interoperable. An open system architecture can involve modules which are responsive in a known manner to known inputs, for example to perform actions or provide responses to queries, inputs or stimuli in a predictable (possibly standardized) manner. Modules in an open system architecture can provide functionalities as a service in that they respond to inputs or stimuli in a particular way, thus providing such functionalities. A service may be provided by a server to a client, and thus the “as service” model may involve a server-client model.

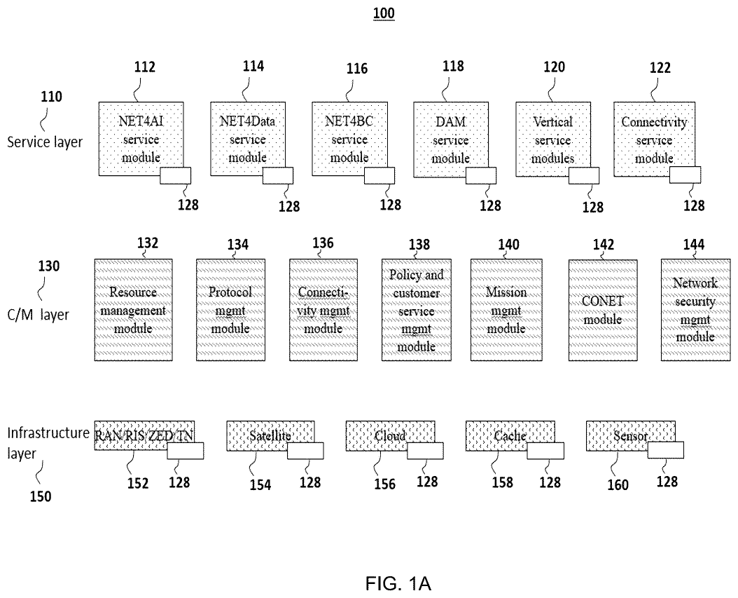

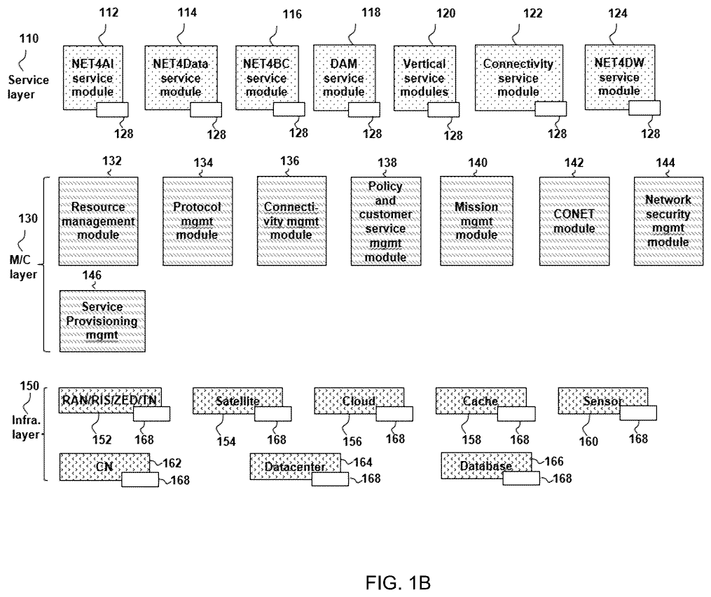

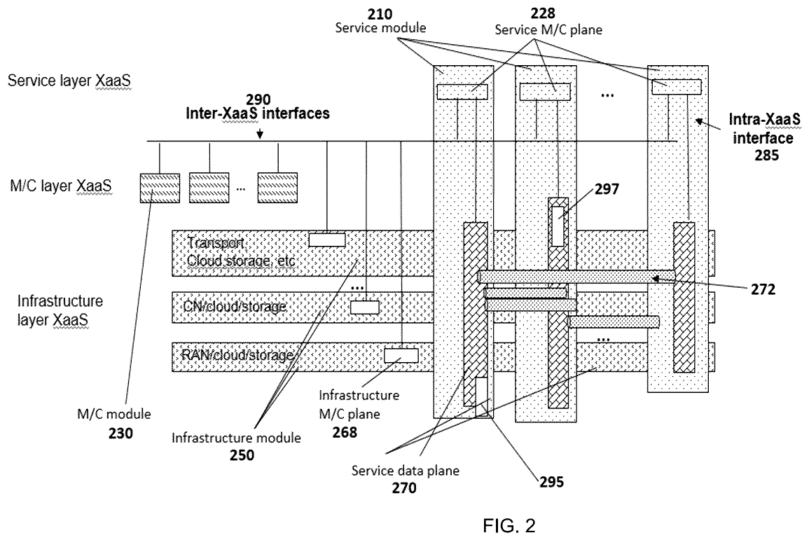

According to embodiments of the present disclosure, there is provided an X-centric network implementation which is provided at least in part using cloud-based (e.g. virtualized and networked) resources. The cloud-based implementation can be viewed as a particular implementation of a more general X-centric network architecture which is described below for example with respect to FIG. 1A. The X-centric architecture of FIG. 1A, and related technologies, is described in U.S. Patent Application No. 63/347,365, filed May 31, 2022, the entirety of which is incorporated herein by reference. The X-centric architecture of FIG. 1A can be viewed separately from a variety of implementation scenarios, such as the implementation scenario of the present disclosure. FIG. 2 illustrates further details of the X-centric architecture, and is also described below.

The term “X-centric” may refer to the capability of embodiments to be reconfigurable so that they are either infrastructure-provider centric, third-party centric, customer centric, or the like, or a combination thereof. Other types of configurations may also be supported. Multiple possible mappings between parties and roles are thus supported, with different X-centric scenarios corresponding to different mappings. This facilitates an architectural openness with support for multiple operation scenarios. A configuration may be centric to a certain entity in that the configuration is directed toward a certain goal related to that entity. An architecture may be X-centric in that it may be configurable to any of a variety of such configurations.

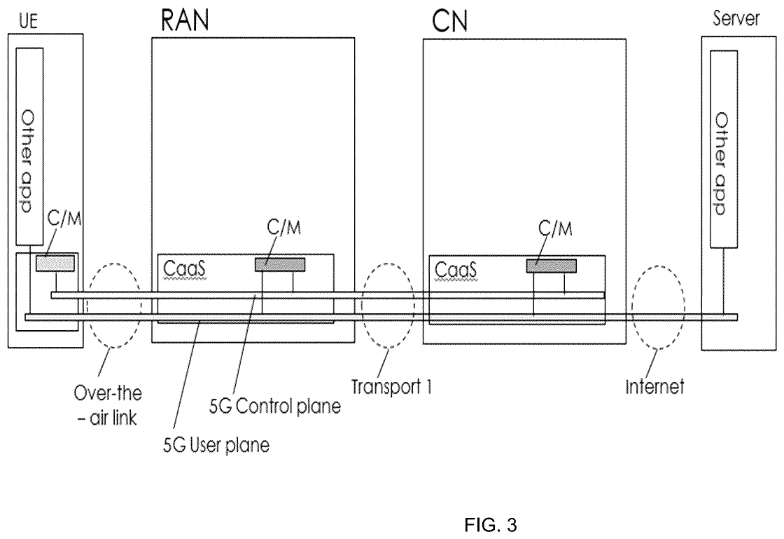

According to embodiments, unified interfaces are deployed in each of a radio access network (RAN), core network (CN) and 3^{rd} party cloud-based networks. In fact, each of these (e.g. RAN and CN) and other networks can be cloud-based networks. Because of the presence of such cloud-based networks, the traditional connectivity centric network implementation architecture is adapted toward a cloud centric implementation architecture. Embodiments of the present disclosure thus provide for a cloud-based X-centric implementation architecture. This can be contrasted with and potentially built upon the 5G implementation architecture as described below with respect to FIG. 3. The unified interfaces can be inter-BAS interfaces, which facilitate interaction among different BASs, e.g. in different clouds. In prior implementations, RAN and CN interfaces were defined based on their infrastructure specific deployment and functions. For cloud-based implementations, RAN, CN, and potentially even devices may use similar “infrastructure” such as cloud infrastructure, even though the clouds may be deployed on top of RAN and CN and devices. In this way there is little to no difference since all XaaS services can be implemented in these clouds, regardless of where these clouds are deployed. Accordingly, a generic basic architecture structure (BAS) which defines XaaS services and GWs to facilitate interaction among them can be defined.

Various embodiments pertain to networks which are cloud-based networks, as mentioned above. Traditional cellular networking parts, such as RAN and CN, can be implemented using a plurality of functions implemented in clouds, e.g. using networked resources configured through virtualization technologies. Substantially generic networked resources can be provided, added and configured as-needed. These resources can be owned by one or a plurality of entities. Third party cloud infrastructure may be part of the network. Even end user devices can be implemented partially or fully in clouds. In some embodiments, virtualized resources provided by a cloud can be accessed, scaled and utilized by a first party, while another party or parties manage the cloud infrastructure itself. This can reduce the overhead requirements of the first party.

Embodiments of the present disclosure relate to a networked computing and communication system comprising multiple different types of modules in an open system architecture. On one layer, infrastructure modules each provide a respective infrastructure resource as service. Infrastructure resources may include real computing, communication or data storage resources. On another layer, service modules each provide a respective functionality as service. Service module functionalities may be functionalities that can be utilized by an end user or other module. The service modules may utilize at least one of the infrastructure resources as service. On another layer, control and management modules each provide a respective management or control resource as service. Control and management resources may be used to manage other modules, missions of modules, module operations, or other management or control tasks. At least one of the control and management modules may provide its respective management or control resource as service to at least one of the infrastructure modules or the service modules. Each module may provide its functionality as a service, on an as-needed basis, to one, some or all modules of the same layer or of different layers. Modules can be interconnected to provide services to one another in a configurable manner depending on operational requirements. Different modules can be provided or operated by different parties, in order to provide for different X-centric configurations, which may be party-centric configurations.

FIG. 1A illustrates an (e.g. X-centric) architecture provided in accordance with an illustrative embodiment of the present disclosure. The architecture 100 includes a service layer 110, a control and management (C/M) layer 130, and an infrastructure layer 150. Different layers may provide different services. Services of each layer are examples of different types of XaaS services. Accordingly, an architecture having three different layers, with XaaS modules in each layer, is provided, which may facilitate openness and extensibility.

The service layer 110 includes one or a plurality of service modules. Service modules can be included or excluded as required for a particular operating scenario. As new service modules are developed, they can be included into an existing architecture or implementation of the network.

By way of example, FIG. 1A illustrates a variety of possible service modules. These examples are not necessarily intended to be limiting. Indeed, embodiments of the present disclosure are capable of hosting service modules which have not yet been conceptualized, and such modules may be added as they are developed or required. Similarly, modules may be omitted where not required. A NET4AI module 112 provides a NET4AI service; a NET4Data module 114 provides a NET4Data service; a NET4BC module 116 provides a NET4BC service; a DAM module 118 provides a DAM service; one or more vertical modules 120 provide one or more associated vertical services; and a connectivity service module 122 provides a connectivity service. Descriptions of each of these modules are provided below. Each module can be provided (e.g. operated) by a different party, or multiple modules can be provided (e.g. operated) by the same party. A service module (e.g. any of the above-mentioned service modules) may provide or offer a service (e.g. NET4AI service, NET4Data service, NET4BC service, DAM service, vertical services, connectivity service) to an end customer (user), to one or more C/M modules in the C/M layer 130, or to other service modules in the service layer 110, or a combination thereof. Service modules can provide services to other service modules in a substantially arbitrary chain or web of interconnections. In various embodiments, any given service module can potentially be provided as a service to any other given service module (in the same layer or another layer) or to an external user or customer.

The NET4AI (network for artificial intelligence) service provided by the NET4AI module 112 may be described as follows. The NET4AI service provides some or all of: artificial intelligence (AI) model customization and management, AI model distribution and parallelization, AI model training, and inferencing optimization. The NET4AI module facilitates providing AI as a service. AI as a service can refer to a service by which AI or machine learning resources can be provided for use by an end user or other service module or any of the C/M modules 130.

The NET4Data (network for data) service provided by the NET4Data module 114 may be described as follows. The NET4Data service provides some or all of: data upload and data storage, data access control and data protection. The NET4Data module facilitates providing data storage (e.g. cloud storage) as a service. Data storage as a service may be deployed to handle an end user's data or the data of another one of the service modules 110 or any of the C/M modules 130. The NET4Data service may store data in one or more computer memories, and may manage features such as data integrity and backup, data redundancy, data retrieval speed optimization, etc. The NET4Data service may also provide for data sharing.

The NET4BC (network for blockchain) service provided by the NET4BC module 116 may be described as follows. The NETBC service provides generic control and management of block chain operations. The NET4BC service handles block data and enables block chain as a service.

The DAM (data analytics and management) service provided by the DAM module 118 may be described as follows. The DAM service provides some or all of: data collection and verification, data privacy protection, data analysis, and data delivery. The DAM service handles all types of data and enables data analytics and management as a service. The DAM service may also provide for data sanitization.

Vertical services provided by the vertical module(s) 120 may include a vehicle to everything (V2X) service, an Internet-of-Things (IoT) service, a metaverse service, etc. Handling vertical (e.g. V2X, Metaverse) customer's data traffic. A vertical service may generally be described as a service which is associated with a vertical service provider. A vertical service provider may provide one or more specialized products or services in a particular niche. Examples of vertical service niches include banking, manufacturing, education, real estate, government or law.

The connectivity service provided by the connectivity service module 122 may facilitate provisioning of data connectivity between devices or endpoints. For example, data connectivity may be provisioned between a device and a data network (DN), between two application services or servers, or the like. The connectivity service may facilitate providing data connectivity as a service. In various embodiments, the connectivity service may handle end user's data traffic, such as voice traffic or application layer data. The connectivity service may include a 6G connectivity service. In some embodiments, the connectivity service module 122 is integrated with the mission management module 140. For example, the connectivity service module 122 may be integrated within the mission management module 140 such that the mission management module 140 provides the connectivity service.

As used herein, a service provided by a service module in the service layer 110 may be referred to as an XaaS service. Because the service is provided at the service layer 110, it is referred to as a service layer XaaS service.

A service module may include one or multiple network functions. A service module may provide an associated service using these network functions. When the service module includes only one network function, the service module may be equated with (or may be) this included network function.

In various embodiments, a service has its own data process which is implemented by some or all of the one or multiple network functions of the service module. Data processes may include computing or data processing, data storage, block creation, data de-privacy operations, etc.

The C/M layer 130, (which may also be referred to as the control and management (C/M) layer) includes one or multiple C/M modules.

By way of example, FIG. 1A illustrates a variety of possible C/M modules. These examples are not necessarily intended to be limiting. A resource management (RM) module 132 provides a RM service. A protocol management (PM) module 134 provides a PM service. A connectivity management (C/M) module 136 provides a connectivity service. A policy and customer service management (CSM) module 138 provides a policy and CSM service. A mission management (MM) module 140 provides a MM service, where missions are as described elsewhere herein. A confederation of networks (CONET) module 142 provides a CONET service. A network security management (NSM) module 144 provides a NSM service. Each C/M module can be provided by a different party. One or more C/M modules can be provided by the same party. An C/M module (e.g. any of the above-mentioned C/M modules) may provide an C/M service (e.g. RM service, PM service, CM service, CSM service, CONET service, NSM service) to an end customer (user) (which may be an external customer or user), to one or more infrastructure modules in the infrastructure layer 150, to one or more of the service modules in the service layer 110, to other C/M modules in the C/M layer 130, or the like, or a combination thereof.

The RM service provided by the RM module 132 may be described as follows. The RM service may manage resources in a static way or a dynamic way. The managed resources may include resources provided by the infrastructure layer, such as wireless resources, wireline resources, computing resources, storage resources, and sensing resources. Managing resources may include managing and controlling network slicing and data routing. The RM service may provide a capability of life-cycle management of one or more network slices and over-the-air resource assignments to wireless devices.

The PM service provided by the PM module 134 may be described as follows. The PM service may provide software-define protocol functionalities, such as packet processing function chain and configuration, protocol stack selection and configuration, protocol parameter tuning and optimization, or the like, or a combination thereof. This PM service may also be referred to as a software defined protocol (SDP) service. The PM service may provide a capability to design service customized protocol stacks for identified interfaces. The protocol stacks may be pre-defined for on-demand selection. The protocol stacks may be designed on demand.

The C/M service provided by the C/M module 136 may be described as follows. The C/M service may provide connection management, mobility management, handover, path switching, registration management, paging, power saving management, or the like, or a combination thereof.

The CSM service provided by the CSM module 138 may be described as follows. The CSM service may provide authentication, identification (ID) management, key management (traffic protection), authorization, service level agreement (SLA) management, SLA enforcement, policy/rule/regulation assurance, installment (charging), or the like, or a combination thereof. SLA may refer to a service level agreement between any two or more of a variety of parties. For example, an SLA may be between parties operating in the service layer, parties operating in the C/M layer, parties operating in the infrastructures, or the like, or a combination thereof. Each of these parties may have one or multiple roles as described elsewhere herein for example with respect to described X-centric scenarios.

The MM service provided by the MM module 140 may be described as follows. The MM service (or the MM module providing the MM service) may transform the data processes of one or more relevant service modules in the service layer to a mission, for example upon request. The MM service may manage (e.g. establish, modify and configure) communication tunnels between the service data planes of the relevant service modules to support the mission. Missions may be as described elsewhere herein, for example in relation to cross-layer, cross-service interactions. In some embodiments, the MM service (more precisely, the MM module 140 providing the MM service) may invoke (i.e. use) the connectivity service (provided by the connectivity service module 122) to manage (e.g. establish, modify and configure) communication tunnels between the service data planes of the relevant service modules to support the mission, and the connectivity service (more precisely, the connectivity service module 122 providing the connectivity service) manages the communication tunnels correspondingly. A mission may be a service provided to customers. A mission may be a type of service which is provided by a single service or using contributions from multiple services. The MM service provides a capability to program provisioning of XaaS services at the service layer to provide mission services. In some embodiments, the MM module 140 is integrated with the connectivity service module 122, for example, integrated within the connectivity service module 122 such that the connectivity service module 122 provides the MM service.

The CONET service provided by the CONET module 142 may be described as follows. The CONET service may provide or facilitate trust consortium establishment, consortium member joining or leaving, block chain management including creation, update and deletion. The CONET service may also be referred to as a block chain for network (BC4NET) service. CONET refers to a confederation network. The CONET service may involve or facilitate confederation formulation, mutual authentication, mutual authorization among partners and negotiation of agreement on recording and retracing of selected actions performed by such partners. This may be performed in order to provide for a trustworthy environment of system operations.

The NSM service provided by the NSM module 144 may be described as follows. The NSM service may provide or facilitate equipment operation security risk detection, network operation security risk detection, network operation security risk prediction, or the like, or a combination thereof. The NSM service may also be referred to as security for network (SEC4NET) service. The NSM module 144 provides network security as a service. This may provide a capability for infrastructure owners to detect potential security risks of or to their infrastructure assets, for example.

In various embodiments, a C/M service provided by a C/M module may be an Xaas service. Because the service is provided at the C/M layer, it may be referred to as a C/M layer XaaS service.

In various embodiments, the C/M module comprises one or multiple network functions and provides the C/M service using these network functions. When providing the C/M service, the C/M module may utilize service-layer XaaS services. When the C/M module includes only one network function, the C/M module may be equated with (or may be) this network function.

In various embodiments, the C/M service has its own signaling process which is implemented by some of the one or multiple network functions of the C/M module. The signaling processes may include, for example, management signaling, control signaling, or the like, or a combination thereof.

The infrastructure layer 150 includes one or more infrastructure modules. The infrastructure modules may provide or offer diversified infrastructure resources. The infrastructure modules may include terrestrial communication modules 152. Examples of terrestrial communication modules include a radio access network (RAN) module, a reconfigurable intelligent surfaces (RIS) module, a zero energy devices (ZED) module, and a transport network (TN) module. The infrastructure modules may include non-terrestrial communication modules 154, such as satellite network communication modules. The infrastructure modules may include cloud modules 156, such as data center networks. The infrastructure modules may include caching modules 158, such as caching nodes. The infrastructure modules may include sensor modules 160, such as sensor nodes or sensor networks.

Each infrastructure module can be provided by a different party, or multiple infrastructure modules can be provided by the same party. Providing may include providing and operating a module, or operating an already provided module. An infrastructure module (e.g. any of the above-mentioned infrastructure modules) may provide an infrastructure service (in the form resources) to an end customer (user), to the service layer or module thereof, to the C/M layer or module thereof, to other infrastructure modules in the infrastructure layer, or the like, or a combination thereof. The infrastructure service provided by an infrastructure module may be referred to as an infrastructure layer XaaS service. Each infrastructure module, or the plurality of infrastructure modules, may be provided by a single provider or by multiple providers.

As also illustrated in FIG. 1A, each service module in the service layer 110 may include or be operatively coupled to its own respective service C/M plane component 128. Similarly, each infrastructure module in the infrastructure layer 150 may include or be operatively coupled to its own respective infrastructure C/M plane component 168. Such C/M plane components are described in more detail with respect to FIG. 2, and in this respect, it is noted that the components 128, 168 of FIG. 1A may be the same as components 228, 268 of FIG. 2, respectively. The C/M plane components 128, 168 may be dedicated control functions for the module to which it is associated. In various embodiments, each C/M plane component 128, 168 is connected to each other C/M plane component 128, 168 and also to each module of the C/M layer 130. Connection may be via inter-XaaS interfaces. Each module of the C/M layer 130 may also be interconnected in this manner. Thus, a full mesh network may operatively couple all of the modules of the C/M layer and all of the C/M plane components. Accordingly, the C/M layer modules and C/M plane components can be controlled in a coordinated manner. For example, the C/M layer may control the behaviour of each service module via such a full mesh network. The C/M plane components 168 may be used for infrastructure management. Each of the illustrated infrastructure modules is a different type of infrastructure provided as a service.

FIG. 1B illustrates an embodiment having the same components as FIG. 1A, as well as some additional components, according to an embodiment. In particular, in FIG. 1B a NET4DW service module 124 is included in the service layer 110, a service provisioning management module 146 is included in the C/M layer 130, and a core network (CN) infrastructure module 162, a datacenter infrastructure module 164 and a database infrastructure module 166 are provided in the infrastructure layer 150. The CM module may provide a service to the digital world.

The RAN infrastructure module 152 and the core network (CN) infrastructure module 162 may interoperate as complementary parts of one or more wireless networks. A datacenter infrastructure module may operate similarly to the cloud module 156, to provide datacenters or related capabilities. A database infrastructure module may similarly provide for database-specific capabilities, for example in the form of one or more databases responsive to database queries or data storage operations.

The modules of the C/M layer 130 may be provided and deployed by using network slicing. These modules may also utilize (e.g. via network slicing) resources provided by the infrastructure layer.

A service provisioning management module 146 in the C/M layer may provide a capability of control and management of service access by customers and provisioning of requested services. This capability may be provided using unified mutual authentication, authorization and policy, key management, QoS assurance and charging between any pair of XaaS service provider and customer. Customers in this sense may include end customers in the physical world, and digital representatives in the digital world, or both.

In various embodiments, XaaS services in the C/M layer 130 support control and management of the 6G System itself, and also provide support to verticals if requested. One example is that the RM service 132 can serve RAN for over-the-air resource management and can also provide service to a vertical for the vertical's over-the-air resource allocation to its end-customers. The XaaS modules in the C/M layer 130 can be deployed by using slicing techniques.

A NET4DW service module 124 in the service layer provides digital world functionality and related services. The digital world functionality and related services (i.e. the digital world services in short) provide a capability to construct, control and manage a digital world. The digital world is defined as a digital realization of the physical world. Digital world, for example Metaverse, provides an interactive, multi-user environment which is intended to emulate various physical aspects of the real world. Sensors may be used to obtain digital world participant data, and the digital world may react to this sensor input, for example by providing corresponding outputs to the participant or other remote participants, in order to make the user experience immersive. The NET4DW service module may handle digital world participant data in order to facilitate such an experience, obtain and utilize network resources to facilitate the experience to a desired quality, manage participation, direct user experiences, etc.

The services provided at the service layer 110 may be developed and deployed by using resource provided in infrastructure and utilizing Network Function Virtualization and Slicing techniques. The capability of each of service may be provided by its control and management functions and service specific data process functions.

In addition to supporting XaaS services at the service layer 110, 6G embodiments may leverage 5G system for provisioning of vertical services (see also 120). A difference between 6G XaaS services and other verticals are that a vertical is a pure customer which needs other XaaS services to enable its operation, while each of XaaS services provide their capabilities to 6G customers.

In various embodiments, an arbitrary pair of XaaS services of the 6G System may be the mutual customer and provider of one another. A first service may have a second service as a direct or indirect customer, and the first service may also be a direct or indirect customer to the second service. A first service may rely on other services directly or indirectly, which in turn rely on the first service directly or indirectly. An indirect customer is a customer of a customer, for example. As examples, an infrastructure owner may provide its resource to XaaS services in Service Layer and C/M Layer; RM services may use the capabilities provided by NET4AI, DAM and NET4DW for its resource management for vertical slicing; CONET service and NET4Data service may use the capability provided by NET4BC for their operation.

The use of modules, such as service modules, C/M modules and infrastructure modules, may facilitate a customizability of the architecture as disclosed herein. Modules can be provided on an as-needed basis, with unnecessary modules omitted. This can streamline and simplify implementation of the architecture. Furthermore, as future services become available, they can be encapsulated in new modules and added on an as-needed basis. Each module may be substantially self-contained and interoperate with other modules or system components using a defined interface or protocol. Thus, adding a module or removing a module can be done without necessarily reconfiguring the other modules. This facilitates a ready reconfigurability of the architecture.

Different system modules as described above (e.g. service modules, C/M modules, infrastructure modules) may be provided by different parties. Parties can be business entities, “players”, etc. A business entity can be focused on providing one or more products or services, for example communications or computing infrastructure, software services, applications, utilities, consulting, government, or the like, or a combination thereof. Three different roles that can be taken on by a party include: service layer XaaS provider, C/M layer XaaS provider, and infrastructure layer XaaS provider. A party providing at least one service module at the service layer takes on the service layer XaaS provider role. A party providing at least one C/M module at the C/M layer takes on the C/M layer XaaS provider role. A party providing at least one infrastructure module takes on the infrastructure layer XaaS provider role. A party may provide modules at more than one layer, thus taking on multiple roles.

Embodiments of the present disclosure also exhibit cross-layer interaction, cross-service interaction, or both. FIG. 2 illustrates an embodiment of the present disclosure, in which a service module 210 includes (or is associated with) a service C/M plane component 228 and a service data plane 270. The service C/M plane component 228 may implement functionalities of the C/M layer for managing and controlling the service data plane 270. Each service C/M plane component 228 and service data plane 270 may be dedicated to a single particular service module 210. The service C/M plane component 228 (or simply service C/M plane, or C/M plane) may include one or multiple network functions (referred to as controllers). The service data plane 270 (or simply data plane) may also include one or multiple network functions (referred to as processing functions). These network functions may be logical functions and can be dynamically deployed. The service modules 210 may be the same as the service modules of the service layer 110 of FIG. 1A.

In various embodiments, one or both of two types of processing functions may be included in the service data plane 270. These two types of processing functions are data processing functions and header processing functions. Data processing functions implement service-specific logic and processes service data, e.g. for the purpose of AI training, data sanitization, private data access control, integration of multiple streams for meta-verse, etc. Header processing functions implement connection/communication logic and perform header processing, e.g. for the purpose of routing, QoS handling, traffic detection, traffic gating, etc. The service data plane 270 may accordingly be further divided into a processing plane and a connection plane. The processing plane includes the data processing functions. The connection plane includes the header processing functions. In some embodiments, the service data plane 270 includes only data processing functions, and the connection plane is optional. In some embodiments, the service data plane 270 includes only header processing functions, and the processing plane is optional, for example, when the service module 210 is a connectivity service module, such as the connectivity service module 122.

The service modules 210 may be provided using, or supported by, infrastructure modules 250, which may be the same as the infrastructure modules of the infrastructure layer 150 of FIG. 1A. The infrastructure modules 250 may for example be provided as a service for implementing the service modules 210. Thus, according to the XaaS approach, modules may be implemented or supported at least in part using infrastructure modules. A service module (or service layer XaaS) may use one, some or all types of available infrastructure modules (or infrastructure layer XaaS).

In various embodiments, when a service module 210 offers an XaaS service, associated processing function(s) may receive service data from each other, or from other network functions (e.g. a service data plane of another service module). Such processing functions may process received data traffic carrying data (service data) related to the service that the service module offers. Such processing functions may additionally or alternatively transmit service data (which may be the processed service data and which may be included in a processed data traffic for transmission) to each other or to other network function(s). For example, processing functions may transmit service data to processing function(s) of a different service module using one or multiple interconnections 272. The data traffic (whether received or transmitted) may include information indicating a type of the service data, e.g. data for process, AI model, pre-sanitized data, post-sanitized data, etc. The data traffic may further include information identifying how the service data should be processed, e.g. a process code or index. The data traffic may include information such as source entity ID, destination ID, path ID or sequence of process, etc., and the information may then be used by the processing functions to route the data traffic properly (e.g. using the right path). The information described above may be included in a data packet, e.g. in the header of the data packet or in the payload field of the data packet (e.g. as part of the service data). The data packet belongs to the data traffic.

In various embodiments, a service C/M component 228 includes one or more controllers, and a service data plane 270 includes one or more processing functions. The one or more controllers manage or control the one or more processing functions using one or more intra-XaaS interfaces 285. The intra-XaaS interfaces may facilitate operative coupling between the service C/M plane component 228 and the service data plane 270. The service data plane 270 and the service C/M component 228 may belong to the same service module. Each of the one or more controllers may manage or control one or multiple ones of the one or more processing functions. Examples of such a controller managing or controlling such a processing function include: determining or configuring location (network location) of the processing function, determining or configuring interconnection between multiple processing functions, determining or configuring operation parameters of a processing function, or the like. Such control may be performed to facilitate or ensure satisfactory or optimal performance of the XaaS service.

At least one infrastructure module 250 includes (or is associated with) an infrastructure C/M plane component 268 (also referred to as an infrastructure C/M plane), which may be the same as the infrastructure C/M plane component 168 of FIG. 1A. The infrastructure module 250 may be located at the infrastructure layer 150. The infrastructure modules 250 may be the same as the infrastructure modules of the infrastructure layer 150 of FIG. 1A. The C/M plane components, the service C/M plane components, or both, may be provided using services of one or more of the infrastructure modules.

The infrastructure C/M plane component 268 may implement functionalities of the C/M layer for managing and controlling the resources provided by its associated infrastructure module 250. The infrastructure C/M plane component 268 (or simply C/M plane) includes one or multiple network functions (also referred to as controllers). These network functions may be logical functions and can be dynamically deployed.

The service data planes 270 of one, some or all of the service modules 210 can be interconnected via interconnections 272. The interconnections 272 may be in the form of tunnels. The interconnections can be used to facilitate providing the functionality of one service module as a service to another service module. The interconnections can be used to form an interconnected plurality of service modules, referred to as a graph. The interconnections can be provided as a service by one or more of the infrastructure modules. Some service modules can be interconnected in this manner, while others are not, thus influencing the topology of the graph, for example on an as-needed basis to support a given operating scenario. Devices (terminals), application servers (AS), or the like can be attached or connected to the graph via further operative links, on an as-needed basis. For example, terminals 295 can be connected to one service data plane 270, and an AS 297 can be connected to another service data plane 270. Multiple types of tunnels may pass through a subset of service layer XaaS service data planes.

In various embodiments, at least one service module in the service layer may have its own data plane. In some embodiments, each service module may have its own data plane. The data planes of the service modules in the service layer can be connected together by interconnections, which may be an arbitrary type of tunnel. This facilitates flexible data plane connections.

In various embodiments, service data is transmitted on the graph and processed by one or more service data planes of one or more service modules, so that a data processing purpose is achieved. The data processing purpose is referred to as a mission. Examples of missions include training an AI model, and collecting and analyzing data. Different missions may involve different service modules. Two or more service modules may cooperate to fulfill a mission. In some embodiments, a mission may involve only one service module. A mission may be created or requested by an end customer or by the C/M layer or C/M module thereof. The use of missions can potentially support complicated processing logic, openness, and extensibility. Terminals, ASs, or both, can participate in data processing for a mission. This allows terminal devices and ASs to contribute to computing and processing tasks that occur in a network. For example, the terminal devices or ASs may operate to support a specified mission for example as managed by an MM module and involving one, two or more service modules.

For example, referring again to FIG. 2, a mission may involve multiple service modules 210. The related data processing may span the service data planes 270 of these multiple service modules. The interconnections 272 may facilitate communication between these multiple service modules to facilitate the data processing.

In various embodiments, the C/M planes 228 of service modules 210 in the service layer (e.g. service layer 110 of FIG. 1A), the C/M planes 268 of infrastructure modules 250 in the infrastructure layer (e.g. infrastructure layer 150 of FIG. 1A), and the C/M modules 230 in the C/M layer (e.g. C/M layer 130 of FIG. 1A) are communicatively coupled to one another. The communicative coupling can be provided in the form of a full mesh, such that any two entities (C/M planes C/M modules) can communicate directly. This full mesh interconnection may involve the entities being connected to a communication bus, which (or components of which) may be referred to as inter-XaaS interfaces 290. Alternatively, interconnection may be partial, so that some entities may have to communicate with one another via another entity acting as a relay. The inter-XaaS interfaces 290 between modules, potentially forming a full mesh structure, allows any two system modules to interact at the C/M level to facilitate making optimal decisions, consistent C/M decisions, or a combination thereof. The inter-XaaS interfaces or associated communication bus may be provided as a service by one or more of the infrastructure modules, or by using services of the one or more infrastructure modules.

The C/M modules 230 can provide information regarding network dynamics to the controllers. This information can include, for example, an indication of a device accessing to or leaving from a mission, a mission requirement change, a resource availability change, etc. The information may influence or control the service C/M planes' decisions regarding managing or controlling respective processing functions in service data planes of the service modules, on a per mission basis. For example, a controller in a service C/M plane may base such decisions at least in part on the information received from the C/M layer. As such, the C/M layer can manage, control, or coordinate the behavior of each service module in the service layer according to network dynamics so that the service layer can provide a desirably good or best overall performance for each mission.

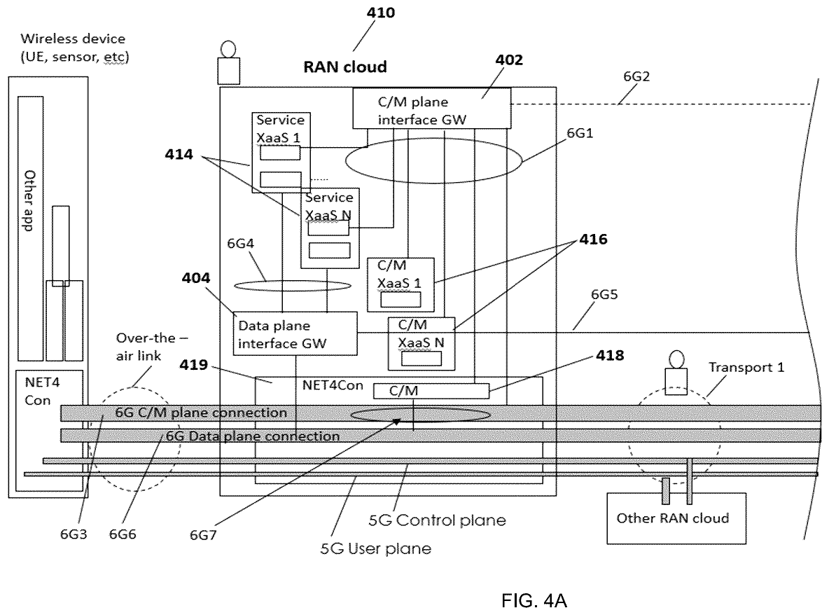

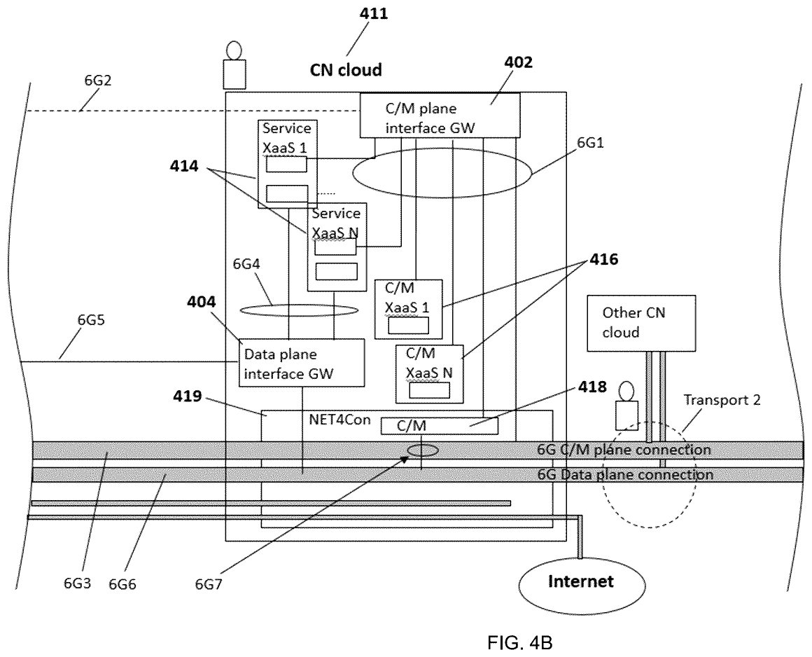

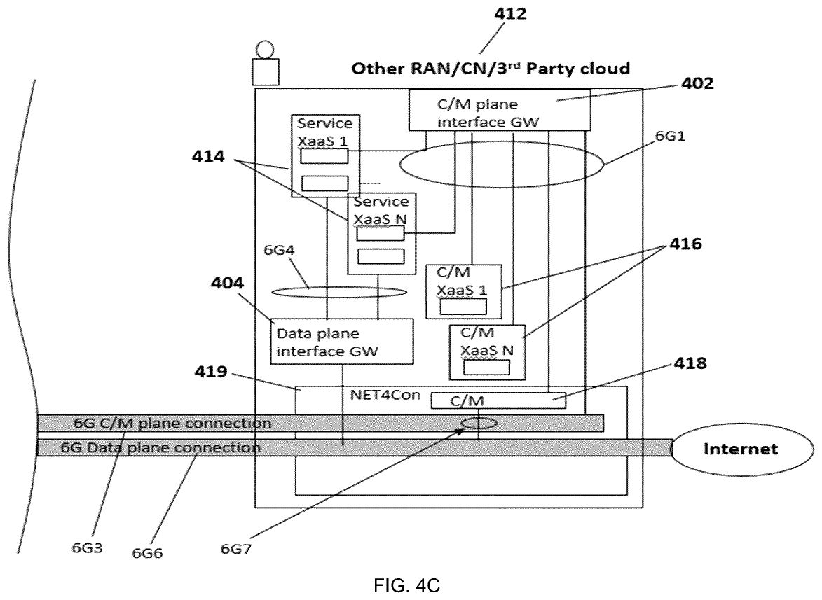

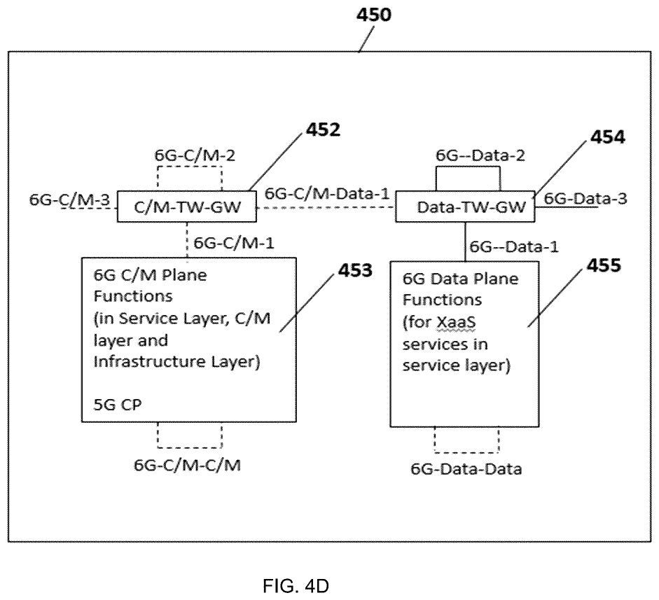

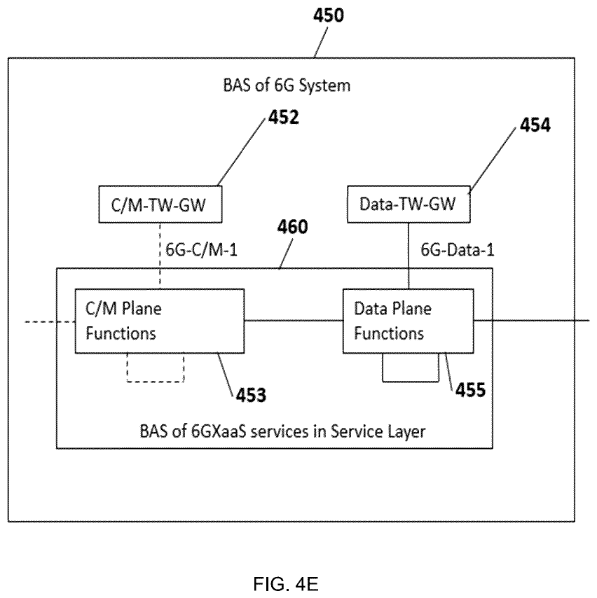

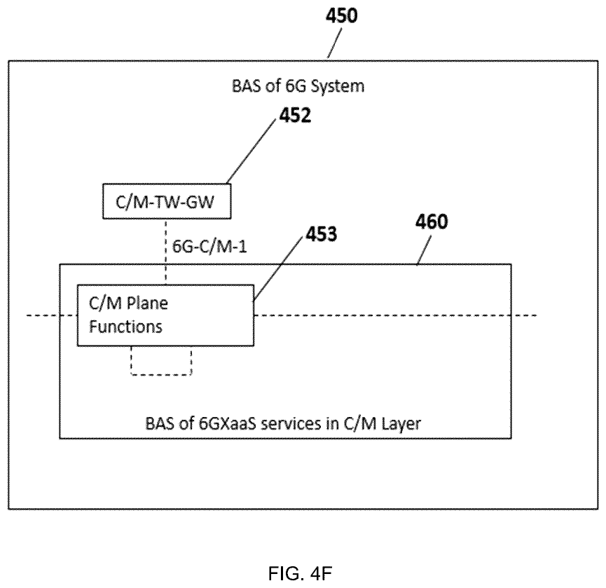

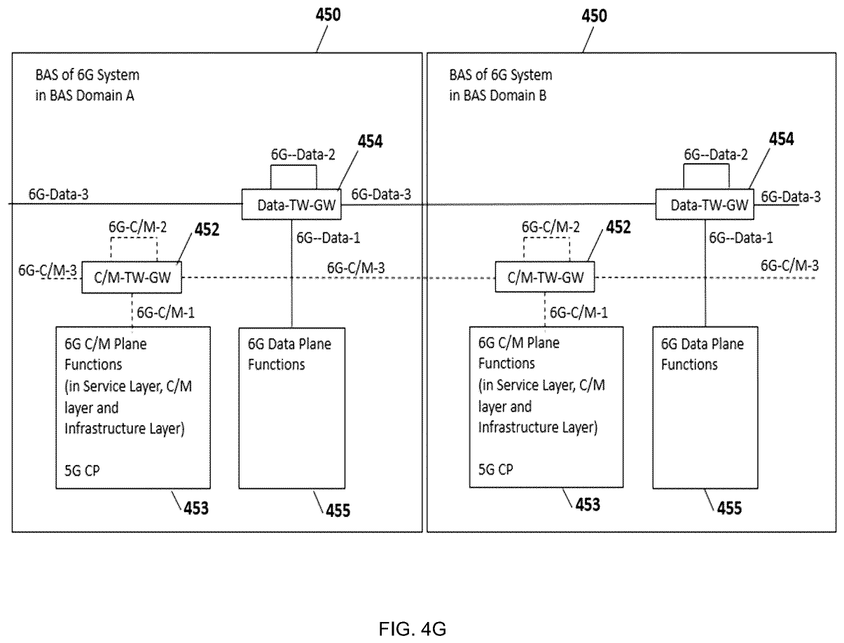

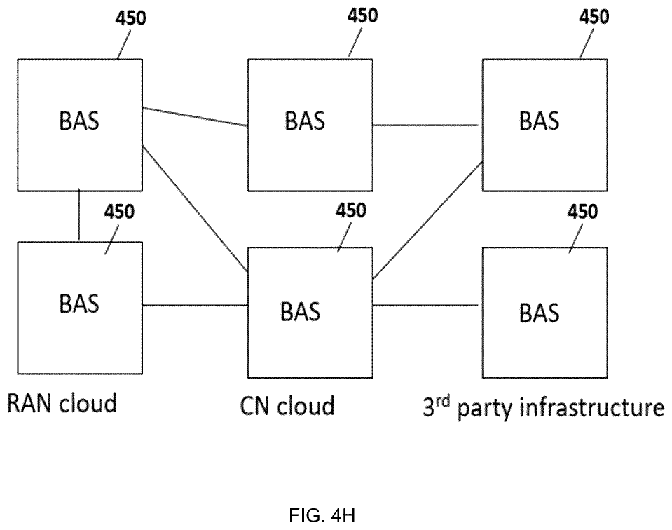

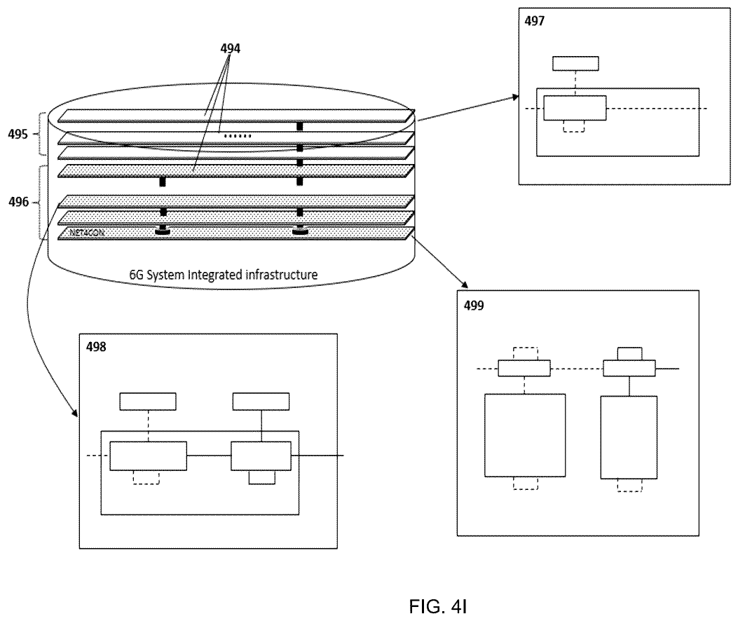

FIG. 3 illustrates a 5G implementation architecture, upon which embodiments of the present disclosure can be provided. For example it is noted that the embodiments of FIGS. 4A-4C are overlaid on the general architecture of FIG. 3 and can thus coexist with that architecture.

FIG. 3 illustrates a UE, a RAN, a CN, and a server accessed via the Internet. The 5G network provides connectivity as a service (CaaS). In this way the 5G network provides connections between a customer UE and services of service providers. The 5G network includes three planes: a user plane (or data plane) for user-related traffic, a control plane for carrying traffic for control of the user plane, and a management plane for performing tasks such as QoS control and charging control, in relation to users. Conventionally, the RAN and CN are owned by a single operator. The RAN and CN are typically implemented using specific equipment, with only very limited (if any) cloud infrastructure being implemented for the RAN and CN.

According to FIG. 3, a UE communicates with a server in order to support an application running partially on the UE and partially on the server. The communication is via a CaaS service as provided by the 5G network. C/M modules may be provided in the RAN and CN to support this connectivity. The communication includes 5G user plane communication. 5G control plane communication is also supported in order to control the user plane. The UE communicates with the RAN via an over-the-air (e.g. radio) link. The RAN communicates with the CN via another communication link (transport 1) which may be a wired or wireless link. The CN communicates with the server via the Internet or another network connection. Various aspects of FIG. 3 are also present in FIGS. 4A to 4C.

FIGS. 4A, 4B and 4C illustrate a cloud-based X-centric network, according to embodiments of the present disclosure. A RAN cloud 410, a CN cloud 411, and another cloud 412, such as another RAN, CN or 3^{rd} party cloud are illustrated. However there may be more or fewer clouds. Each cloud represents a collection of devices communicatively coupled and implemented for example using virtualization technology. Different devices can be owned by different entities, and the communication infrastructure connecting devices can also be owned by one or more different entities. The wireless device can also be regarded as having a cloud-based structure. For example, the wireless device may have one or more further infrastructure modules, one or more further service modules each providing a respective functionality as service and utilizing at least one of the infrastructure resources as service; and one or more further control and management modules each providing a respective management or control resource as service. At least one of the further control and management modules may provide respective management or control resource as service to at least one of the further infrastructure modules or the further service modules. Other functionalities, gateways, or the like, may also be included in the wireless device. It is noted that each cloud has a similar architectural structure, for unity and simplicity.

FIGS. 4A-4C illustrate, by way of example, N Service XaaS modules 414 and N C/M XaaS modules 416 for each of the RAN cloud, CN cloud, and other cloud. These XaaS modules are located in the service layer and provided via cloud-based infrastructure. These XaaS modules may be the modules 210 of FIG. 2, for example. Furthermore, the Service XaaS modules may be the service layer modules 110 of FIG. 1A and the C/M XaaS modules may be the C/M layer modules 130 of FIG. 1A. The C/M XaaS modules may be C/M layer services. Each XaaS module 414, 416 is coupled to a C/M plane interface gateway (GW) 402 of the same cloud, via C/M plane interfaces 6G1, and different C/M plane interface GWs 402 are coupled together via data plane interfaces 6G2. The C/M plane interface GW 402 is further coupled to the 6G data plane connection 6G6 via a C/M module 418 of the Net4Con functionality 419. Service XaaS modules 414 are coupled to data plane interface GWs 404 of the same cloud via respective data plane interfaces 6G4. Data plane interface GWs 404 of different clouds are coupled together via further data plane interfaces 6G5. Data plane interface GWs 404 are communicatively coupled to the 6G data plane connection 6G6.

For the sake of clarity, intra-XaaS module sub-functions and intra-XaaS module interfaces (interfaces between multiple entities of an XaaS module) are not shown in FIGS. 4A-4C.

Also in FIGS. 4A-4C, the 5G connectivity as a service (CaaS) (see FIG. 3) is extended to a NET4Connectivity (NET4Con) service 419 to support all types of connectivity. For example, the NET4Con service supports not only connections between wireless devices (e.g. UEs) and servers (as in FIG. 3), but also connections between all XaaS modules (e.g. C/M, service and infrastructure XaaS modules) in the X-centric architecture, and connections between XaaS modules and other devices such as wireless devices and servers.

The Net4Con modules of the wireless device and each cloud are coupled together via 5G user plane and 5G control plane connections, as well as a 6G C/M plane connection/interface 6G3 and a 6G data plane connection/interface 6G6. Thus, NET4Con provides a new type of connectivity for 6G C/M plane, in addition to 5G C-plane support. It is noted that 5G control plane can also extended to support the 6G C/M plane connection 6G3. Furthermore, NET4Con modules provide a new type of connectivity for 6G data plane, in addition to 5G user plane support. It is also noted that 5G user plane can also extended to support the 6G data plane connection 6G6.

Embodiments of the present disclosure provide for a 6G C/M plane trustworthy gateway (C/M TW-GW/proxy) in some or all of the clouds. The C/M TW-GW/proxy provides the C/M plane interface GW as described above. A gateway may be trustworthy in the sense that it is provided by a trusted party, secured by a trust system (e.g. a blockchain system), or the like.

Embodiments of the present disclosure provide for a 6G data plane trustworthy gateway (6G Data TW-GW/proxy) in some or all of the clouds. The Data TW-GW/proxy provides the data plane interface GW as described above.

In various embodiments, interactions or signaling massages among all XaaS modules in the X-centric architecture are transmitted via the C/M plane interface 6G3 of the NET4Con modules.

In various embodiments, data transfer among XaaS modules in the service layer of X-centric architectures is performed via the 6G data plane interface 6G6 of the NET4Con modules. These service layers can include, for example, NET4AI, NET4Data, NET4BlockChain, DAM, NET4DigitalWorld, or other service layer modules such as those of service layer 110 of FIG. 1A.

As already mentioned above, different XaaS modules in the X-centric architecture can be controlled or managed by different entities. At least two different entities may be present, each of which controls or manages at least one of the XaaS modules, which may be service or C/M XaaS modules.

In various embodiments, the implementation architecture is unified and cloud based. The architecture design includes functions and interfaces which are implemented within a cloud for example by providing the functions using computing devices via virtualization technologies. The implementation architecture may be applicable to all types of clouds.

In various embodiments, the X-centric implementation architecture is implemented on top of a 5G network. This approach may fully support backward compatibility. Accordingly, the X-centric implementation architecture can co-exist with 5G users and networks.

In various embodiments, a single cloud may include multiple C/M plane interface GWs, multiple Data plane interface GWs, or both. However, for clarity, only a single C/M plane interface GW 402 and a single data plane interface GW 404 per cloud is illustrated.

Embodiments of the present disclosure provide for a unified Basic Architecture Structure (BAS). The BAS includes C/M plane functions, data plane functions and (e.g. trustworthy) GWs in both C/M plane and data plane, and interfaces between these functions. The BAS structure may be a building block which may be reused multiple times for example in different infrastructures (or clouds).

FIG. 4D illustrates a unified BAS 450 according to an embodiment of the present disclosure. This embodiment may have limited or minimized impact on existing 5G architecture and operation, and thus be backward compatible. The BAS 450 of FIG. 4D can support indirect interaction between XaaS services. When the interfaces 6G-C/M-C/M, 6G-Data-Data, or both, are included, the BAS of FIG. 4D can support direct interaction between XaaS services.

With reference to FIG. 4D, a C/M plane trustworthy GW (C/M-TW-GW) 452 is provided which facilitates indirect communication among C/M functions 453 in different XaaS services. The C/M-TW-GW also facilitates connectivity between different BAS domains. A BAS domain may include or refer to the infrastructure (e.g. cloud-based infrastructure) which implements a BAS. The BAS may include the TW-GWs and the interconnections to and from these TW-GWs. Potential benefits of implementing the C/M-TW-GW include simplified SBI interfaces and enabling anonymous interaction among XaaS services for better management of protection of privacy of XaaS service providers. The C/M-TW-GW may be the same as the C/M plane interface GW 402 of FIGS. 4A to 4C.

A data plane Trustworthy GW (Data-TW-GW) 454 enables indirect communication among data plane functions 455 of XaaS services in Service Layer. It may provide similar benefits as that of C/M-TW-GW. The Data-TW-GW may be the same as the Data plane interface GW 404 of FIGS. 4A to 4C. The C/M-TW-GW and the Data-TW-GW may be owned by infrastructure owners.

The C/M functions 453 and data plane functions 455 may be components of XaaS services, such as one of the service modules in the service layer 110 of FIG. 1A or 1B. An XaaS service may include both C/M functions 453 and data plane functions 455.

In the BAS 450 of FIG. 4D, a C/M plane function 453 of a XaaS service, which is to interact with other XaaS services, establishes one secured connection with the C/M-TW-GW. Similarly, a data plane function of a XaaS service, which needs to interact with other XaaS services, establishes one secured connection with the Data-TW-GW. Thus, indirect interaction between XaaS services is possible. This may facilitate anonymous service provisioning, improved management of trustworthiness, or a simplified SBI.

It is noted that the BAS 450 of FIG. 4D defines interfaces of inter XaaS services and inter BAS domains. The interfaces of inter XaaS services may include interfaces 6G-C/M-1, 6G-C/M-2, 6G-Data-1 and 6G-Data-2. 6G-C/M-1 defines interface between a C/M function in a XaaS service and C/M-TW-GW. For example, XaaS service 1 may require a service of XaaS 2. XaaS service 1 thus uses 6G-C/M-1 interface to sends a signalling message to C/M-TW-GW which, after processing, sends the message to XaaS service 2 using 6G-C/M-1 interface. Therefore these interfaces are used for interaction among XaaS services, via C/M-TW-GW. The interfaces of inter BAS domains may include 6G-C/M-3 and 6G-Data-3. It is also noted that a vertical can also indirectly interact with 6G XaaS services through these GWs.

The BAS 450 of FIG. 4D includes following interfaces. The 6G-C/M-1 interface provides C/M plane message exchange between the C/M-TW-GW and C/M functions in XaaS services in the C/M Layer, Service Layer and Infrastructure Layer. The 6G-C/M-1 interface may be the same as the 6G1 interface of FIGS. 4A-4C. This interface also provides message exchange between 5G CP (Control Plane, e.g., AMF) and C/M-TW-GW. The 6G-C/M-2 interface provides message exchange between different C/M-TW-GWs that are in the same BAS domain. The 6G-C/M-3 interface provides message exchange between C/M-TW-GWs in different BAS domains. The 6G-C/M-3 interface may be the same as the 6G2 interface of FIGS. 4A-4C. The 6G-Data-1 interface provides 6G data plane traffic transmission between the Data-TW-GW and data process functions defined in XaaS services in Service Layer. The 6G-Data-1 interface may be the same as the 6G4 interface of FIGS. 4A-4C. The 6G-Data-2 interface provides 6G data plane traffic transmission between different Data-TW-GWs in the same BAS domain. The 6G-Data-3 interface provides 6G data plane traffic transmission between Data-TW-GWs in different BAS domains. The 6G-Data-3 interface may be the same as the 6G5 interface of FIGS. 4A-4C. The Data-TW-GW may interface with the C/M-TW-GW via interface 6G-C/M-Data-1.

When included, the 6G-C/M-C/M interface provides C/M plane message exchange between different C/M functions in XaaS services in the C/M Layer, Service Layer and Infrastructure Layer. The 6G-C/M-C/M interface is used for message exchange between C/M functions of different XaaS services. When included, the 6G-Data-Data interface provides data plane traffic transmission between different data process functions defined in XaaS services in Service Layer. The 6G-Data-Data interface is used for data traffic transmission among data processing functions of different XaaS services.

The BAS 450 of FIG. 4D, with 6G-C/M-C/M and 6G-Data-Data included, defines interfaces of inter XaaS services and inter BAS domains. In this embodiment, a C/M plane function of a XaaS service which is to interact with C/M plane functions of other XaaS services establishes a secured connection with each of these C/M functions. Similarly, a data plane function of a XaaS service which is to interact with data functions of other XaaS services establishes one secured connection with each of these functions. The BAS supporting direct interconnection among different XaaS services may be more suitable to deployment scenarios where only a small number of XaaS services are deployed. The C/M-TW-GW 452 in this embodiment might only perform functions to support message exchanges between BAS domains. The Data-TW-GW 454 in this embodiment might only perform functions to support data traffic transmission between BAS domains. The 6G System may also support direct interactions among XaaS services without introducing the trustworthy GWs. The interfaces 6G-C/M-C/M and 6G-Data-Data may be used for interactions between different XaaS services.

In some embodiments, the 6G System can be configured to support 5G services by introducing 5G as a Service, and integrating 5G service provisioning into the 6G System architecture. In some embodiments, a 5G System can be supported as a 5G as a service (5GaaS) and can be developed and deployed using slicing techniques. The interfaces are the same as those of FIG. 4D, supporting backward compatibility. The illustrated 6G Data Plane Functions can include a 5GaaS UP-m, and the illustrated 6G C/M Plane functions can include a 5GaaS CP-m. The 5GaaS CP-m and 5GaaS UP-m denote the modified CP and UP of a 5G System. Some examples include: Authentication, authorization and key management in 5G CP can be provided by 6G SPM service; Mobility management function of AMF can be provided by 6G CM services; and UPF in 5G UP can interface with Data-TW-GW, depending on implementation preference.

The 6G System BAS can also be utilized in some or all of the XaaS services as an intra-XaaS service BAS. The BAS of a XaaS service is denoted as XaaS BAS. The relationship between 6G System BAS (indirect interaction) and XaaS BAS of a XaaS service in Service Layer and C/M Layer are shown in FIGS. 4E and 4F, respectively.

The BAS of each XaaS service and the relation between 6G System BAS 450 and XaaS BAS 460 are shown in FIG. 4E, which is applicable to the alternatives above (i.e. with or without 5GaaS service). Thus, inter-XaaS service interaction among functions within an XaaS service can define a BAS 460. The principle of BAS can thus be implemented for such inter-XaaS service interaction.

A XaaS service at the Service Layer includes internal data plane functions, with one or more of these functions interfacing with Data-TW-GWs 454 for interaction with other XaaS services. Internal data plane traffic of a XaaS service may or may not pass through Data-TW-GWs when crossing BAS domains, e.g., between RAN and CN, depending on implementation.

A XaaS service at Service Layer also includes internal C/M plane functions with one or more of these functions interfacing with C/M-TW-GWs 452 for interaction with other XaaS services. Similar to dealing with data plane traffic, internal C/M plane messages of a XaaS service may or may not pass through C/M-TW-GWs when crossing BAS domains, e.g., between RAN and CN. Internal interfaces of a XaaS service may or may not be standardized, depending on implementation.

FIG. 4F is similar to FIG. 4E, except that the Data plane functions and Data-TW-GW are omitted. A XaaS service in C/M Layer and Infrastructure Layer includes internal C/M functions with one or some of them interfacing with 6G System C/M-TW-GW 452. Internal C/M plane messages of such a XaaS service may or may not pass through 6G System C/M-TW-GW when crossing domains/infrastructures. The internal interfaces of a XaaS service in C/M Layer may or may not be standardized depending on implementation.

FIG. 4G illustrates the interconnection between two BAS domains, domain A and domain B, according to an embodiment. Each domain is configured similarly to FIG. 4D. The C/M-TW-GWs 452 in the two BAS domains 450 perform message exchange between BAS domains via 6G-C/M-3 interface. The Data-TW-GWs 454 in the two BAS domains perform data traffic transmission between two BAS domains via 6G-Data-3 interface.

FIG. 4H illustrates multiple BASs 450 interconnected together. Each illustrated BAS (or BAS domain) can be implemented in a given cloud infrastructure (e.g. RAN cloud, CN cloud, or 3^{rd} party cloud) and interconnected to one or more other BASs in the same cloud infrastructure, different cloud infrastructures, or a combination thereof, or in a wireless device. Each BAS may be a full BAS or a partial BAS (subset).

FIG. 4I illustrates an X-centric network architecture according to an embodiment. Each basic XaaS service may provide a unique capability, may include multiple functions, and may be deployed in underlying infrastructure. A 6G data plane and C/M plane may be implemented. The infrastructure includes multiple different service layer XaaS modules 494 which may be interconnected for example via tunnels. The modules 494 may include modules of a first type 495 and modules of a second type 496. The first type 495 may consist of C/M layer modules and the second type 496 may consist of service layer modules. The C/M layer modules may have the BAS structure 497, which is illustrated in more detail in FIG. 4F. The C/M layer modules may have the BAS structure 498, which is illustrated in more detail in FIG. 4E. Also illustrated for context is the BAS 499 which is illustrated in more detail in FIG. 4D.

A 6G system as described herein can be developed along any one of multiple development paths. For example, a 6G system can be developed with the above-described 6G System XaaS services, and using 5G System as a basic access system. Such a 6G System may support backward compatibility and may have limited to no impact on 5G service access. As another example, a 6G System can be developed with the above-described 6G System XaaS services and supporting a 5G System as a 5G System as a Service (5GaaS). As another example, a 6G system can be developed with evolution of a 5G System to support 6G services.

According to various embodiments, the 6G system architecture design incorporates a collection of BASs, for example uniformly implementing the BAS in infrastructures of the 6G system. This BAS approach may be utilized in any one of the above development paths. The BAS structures and connections (e.g. interfaces) among these BASs in different infrastructures or clouds may constitute a 6G system architecture.

A full BAS or a subset of the BAS may be deployed in infrastructures based on capability, capacity and specific requirements of the infrastructure. A subset of the BAS may be such that only a subset of XaaS services are implemented in a BAS domain. As one example, a RAN may be a BAS domain and may only implement some of 6G XaaS services due to possible capacity limitation. As another example, a subset of the BAS may be a subset of functions of a XaaS service. As a further example, the TW-GWs in C/M plane and data plane may only perform their forwarding function in a BAS domain if all XaaS services are provided by a single provider in that domain. The BAS may be applied to wireless devices with selected subset of the BAS. Note that a wireless device may be a robot, a drone or an advanced device with enhanced capacity and capability.

In various embodiments, the adaptation of the BAS to different infrastructure networks may be done while retaining the same overall structure and interfaces defined above for the BAS. In various embodiments, the functions defined by 6G XaaS services may be implemented as software defined Virtualized Functions or using dedicated or function-specific hardware to speed up processing wherever applicable.

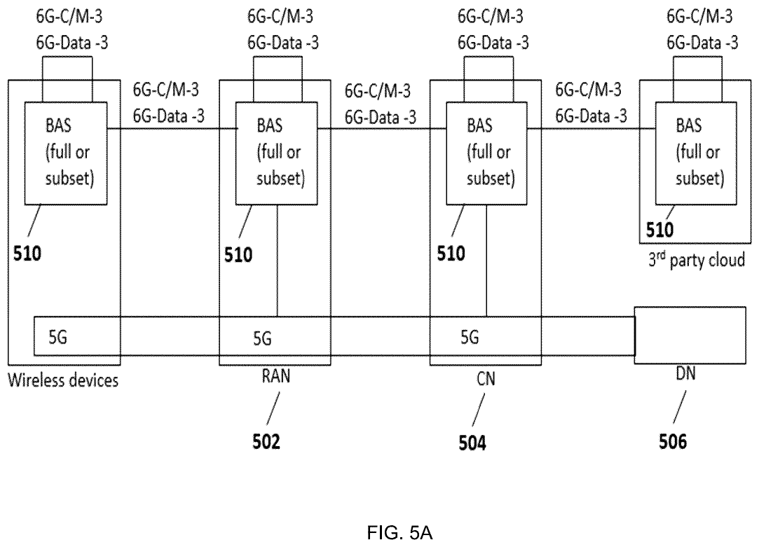

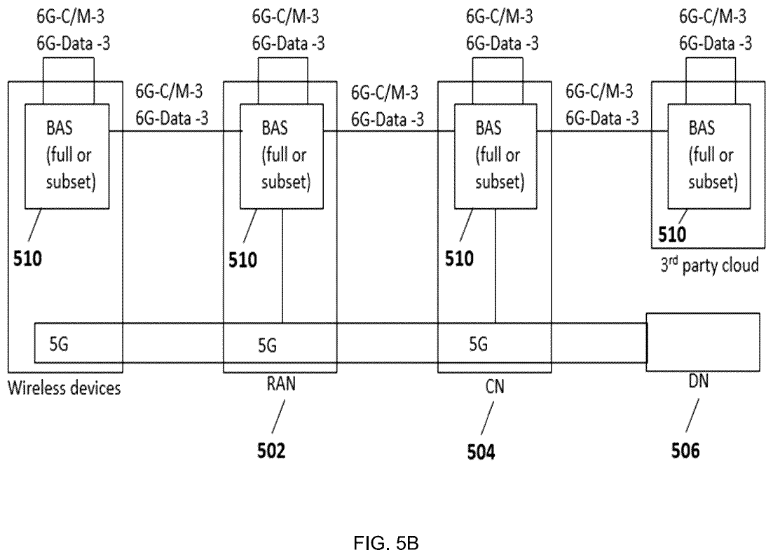

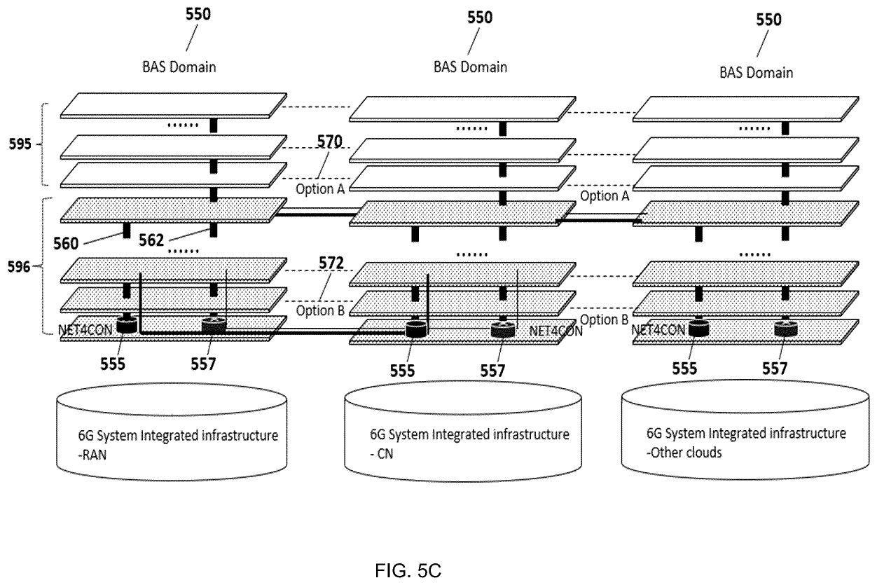

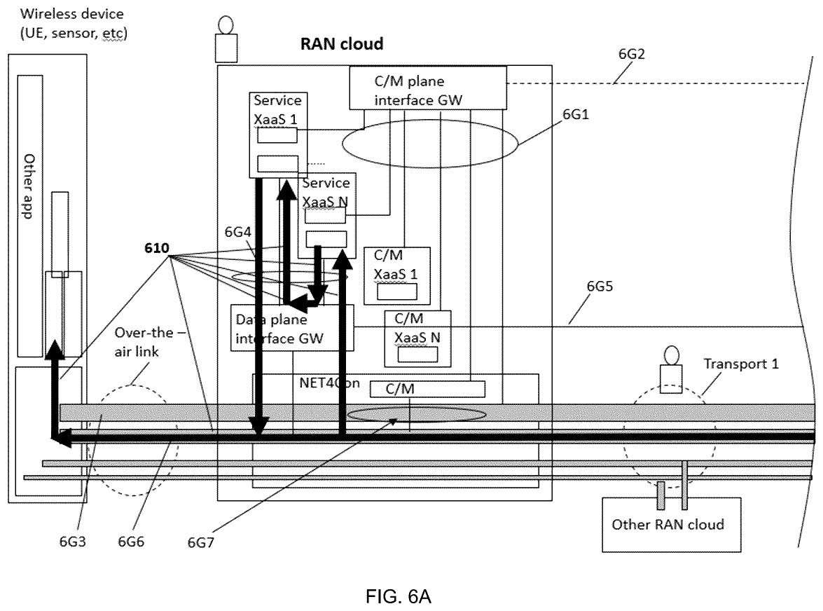

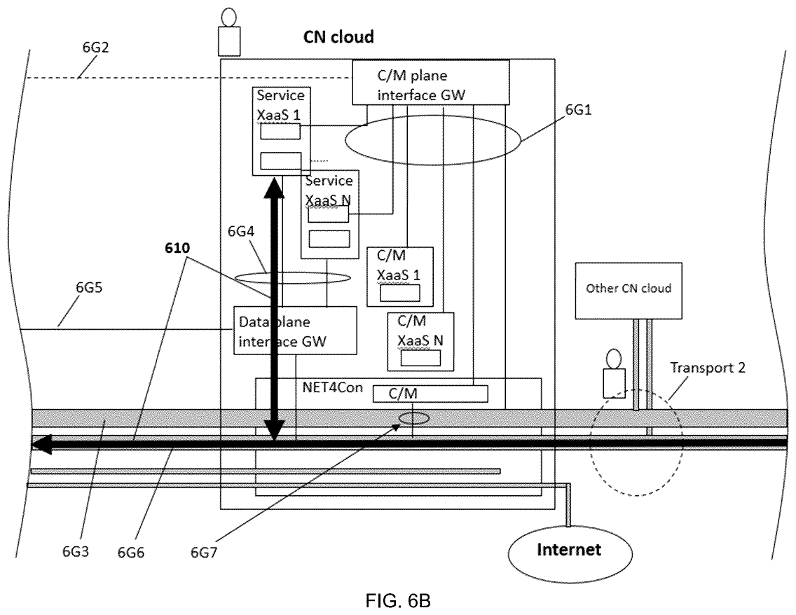

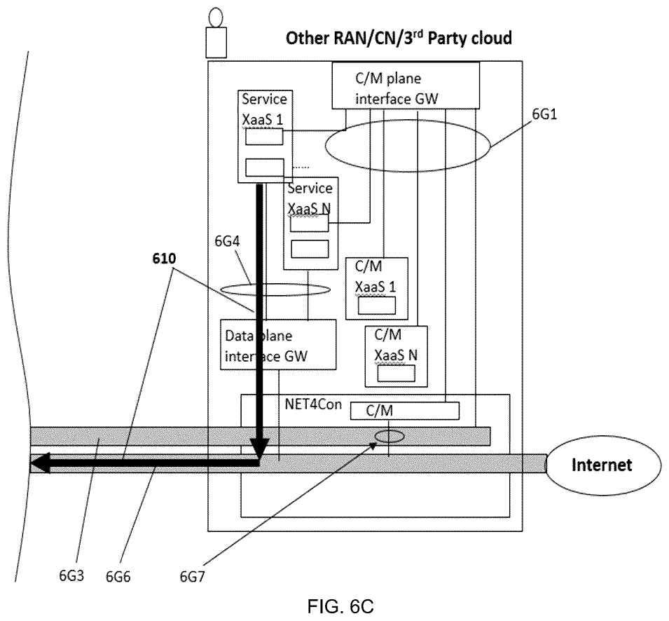

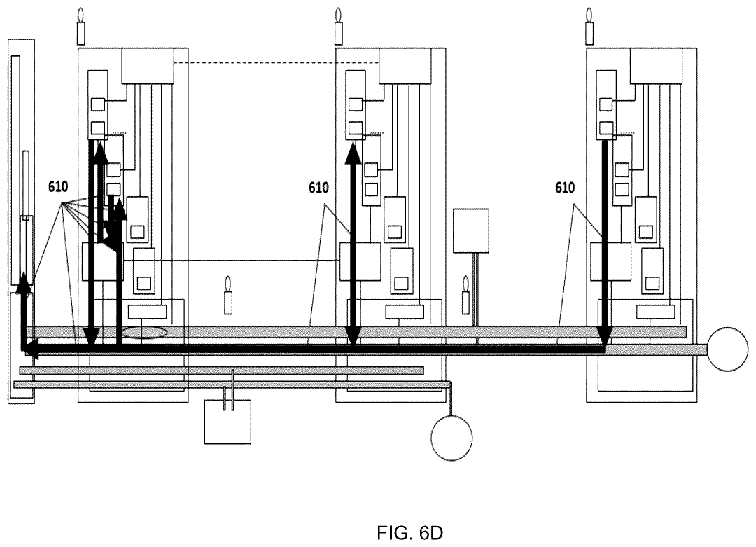

FIG. 5A illustrates a communication system supporting backward compatibility, according to an embodiment. The communication is described using a (e.g. 6G) system architecture reference model as shown. This model comprises BASs 510 and their interconnections, the BASs implemented in multiple domains of infrastructure. These domains may include a RAN domain 502, CN domain 504, and a 3^{rd} party infrastructure domain 506. One or more BASs 510 may also be implemented in the wireless device domain (e.g. in wireless devices themselves), possibly with simplification. Accordingly, each domain may include one or more BASs. Each BAS may be coupled to aspects of a 5G system (e.g. 5G control plane and 5G user plane). Each BAS may be connected to other BASs within the same domain, BASs within other domains, or both. When expanded in terms of detail, the system of FIG. 5A may be similar to the system of FIG. 6D.

The 6G System architecture leverages the service based architecture (SBA) concept and the virtual network and slicing techniques developed for 5G systems. In this reference model, a 5G System is supported by retaining and using a 5G system architecture. In order to support 6G services to end-customers, end-customers can directly access 6G services. Alternatively, customers can access 6G services through the 5G System via a provided interface between 5G CP (e.g., AMF) and the 6G C/M plane via C/M-TW-GWs.

FIG. 5B illustrates a communication system according to another embodiment, as an alternative to FIG. 5A. The system of FIG. 5B is less backward compatible (or not backward compatible) in comparison to that of FIG. 5A. The system of FIG. 5B is similar to that of FIG. 5A, with the 5G components being omitted, except possibly for a 5G-N6 link between the CN and the DN.

The 6G System architecture of FIG. 5B leverages the SBA concept and the virtual network and slicing techniques developed for 5G systems. In this reference model, a 5G System is supported as a service (5G as a Service) of the 6G System. The 6G System allows a 6G UE to access both 5G services and 6G services. In order to support 5G services to end-customers, an end-customers can access to 5G services through 6G System C/M functions.

According to other embodiments, the 6G System as described herein can be defined as an evolution of a 5G System. Following this evolution path, the 5G System can be enhanced to support 6G services. Some of examples of enhancements of a 5G System are as follows. The session management function (SMF) may be enhanced to enable functionalities of mission management (MM) for supporting 6G data plane interaction of 6G services. The access and mobility function (AFM) may be enhanced to enable functionalities of connectivity management (CM) for managing mobility of both physical users (UEs) and digital users (UEs). Functions of authentication, authorization and key management can be enhanced to enable functionalities of service provisioning management (SPM) for unified authentication, authorization and key management among any pair of service provider and consumer, including 6G System customers and all 6G XaaS service providers. The Service Communication Proxy (SPC) and network repository function (NRF) can be enhanced to enable trustworthy GWs and utilize the BAS architecture to simplify service based interface (SBI) and better manage privacy protection of two parties of any interaction in 6G C/M planes. The user plane may be enhanced to provide for a 6G data plane. 6G data plane trustworthy GWs may be provided, and the BAS architecture may be utilized to simplify 6G data plane SBI and better manage privacy protection of two parties of any interaction in 6G data planes. All of the above 6G System development paths may follow substantially the same design principles.

FIG. 5C illustrates intra-XaaS service interfaces according to an embodiment. Intra-XaaS service connections may cross BAS domains. Such connections may pass through C/M-TW-GWs and Data-TW-GWs, or not, depending on implementation. As illustrated, there are multiple BAS domains 550, each utilizing different infrastructure (e.g. RAN, CN or other cloud infrastructure, also referred to as 6G system integrated infrastructures). Each BAS domain 550 can include multiple C/M layer XaaS modules 595, service layer XaaS modules 596, or both. Each BAS domain 550 can also include a data plane GW or TW-GW 555 and a C/M plane GW or GW-GW 557. The GWs or TW-GWs 555, 557 may be associated with or may be included in a Net4Con XaaS module. The data plane GWs or TW-GWs 555 interconnect XaaS modules of the same BAS domain, for example via tunnel interconnections 560. In some embodiments the tunnel interconnections 560 are limited to service layer XaaS modules 596, and do not extend to C/M layer XaaS modules 595. The control plane GWs or TW-GWs 557 interconnect XaaS modules of the same BAS domain, for example via tunnel interconnections 562. Furthermore, in some embodiments, XaaS modules of different BAS domains 550 may communicate directly with one another for example via links 570 (Option A). Additionally or alternatively, XaaS modules of different BAS domains 550 may communicate indirectly with one another for example via links 572 between different Net4Con XaaS modules (Option B). In this case, a first XaaS module communicates with the Net4Con module of the same BAS domain, which passes the communication to a Net4Con module of another BAS domain, which in turn passes the communication to a second XaaS module of that other BAS domain.

Various XaaS modules, including service XaaS modules can be operated together to support a mission. FIGS. 6A to 6C illustrate the same infrastructure as FIGS. 4A to 4C, as well as specific interconnections (thick, dark arrows 610) between multiple modules of multiple clouds, in order to support such a mission, according to an example embodiment. Multiple service XaaS modules of different clouds may be interconnected. Multiple service XaaS modules of the same cloud may be interconnected. Interconnections may be via one or more data plane interface GWs. An application of the wireless device is also involved in such interconnection. The interconnections form a 6G data plane or data process plane. This 6G data plane includes data plane process functions in the service layer XaaS modules and 6G data plane (or data process plane) connections 610. Each supported mission service may similarly have its own associated customized 6G data plane (or data process plane) topology.

FIG. 6D illustrates all of FIGS. 6A to 6C at once, to better illustrate the connections 610 forming the 6G data plane.

The interfaces 6G1, 6G2, 6G3, 6G4, 6G5, 6G6 and 6G7 as introduced above are now discussed in more detail.

Interface 6G1 is an intra-cloud interface between C/M functions of all XaaS modules and the C/M plane interface GW, e.g. the C/M TR-GW/proxy. This interface carries signaling messages among C/M functions of XaaS modules. This interface may be referred to as a 6G C/M service based interface (SBI).

Interface 6G2 is an interface between clouds (e.g. between C/M interface GWs of different clouds) for carry C/M signaling messages among C/M functions of XaaS modules in different clouds. This interface may be between two or more different C/M TW-GW/proxies.

Interface 6G3 is an (e.g. over-the-air) interface for carry C/M signaling messages among C/M functions of XaaS modules in clouds (e.g. the RAN cloud) and 6G wireless devices' clouds. The interface 6G3 may exist between clouds for C/M plane connection.

Interface 6G4 is an intra-cloud interface between data functions of all XaaS modules and the data plane interface GW, e.g. the data TR-GW/proxy. This is an interface for data transfer among XaaS modules in the service layer. This interface may be referred to as a 6G data plane SBI.

Interface 6G5 is an interface between clouds (e.g. between data plane interface GWs of different clouds) for transferring data among XaaS modules in the service layer in different clouds. This interface may be between two or more different data TW-GW/proxies.

Interface 6G6 is an (e.g. over-the-air) interface for carrying 6G data between clouds, such as between the RAN cloud and 6G wireless devices.

Interface 6G7 is an interface between the 6G C/M plane and the 6G data plane to facilitate C/M control and management in the 6G data plane.

The above interfaces may be applicable to all types of clouds. Note that direct interfaces between XaaS modules are not shown. The two end-point communication (signaling and data) between XaaS modules may be directly coupled, or coupled indirectly via a TW-GW/proxy. Indirect coupling only is illustrated.

According to various embodiments, the implementation architecture is unified and cloud based. That is, the architecture design (e.g. including functions and interfaces) is the same or similar within each cloud. This is apparent in FIGS. 4A-4C. This cloud-based, unified architecture may facilitate a simple and rapid implementation of a 6G network. Interface design is simplified. Logical functions and interfaces may be unified in some or all types of clouds, including RAN clouds, CN clouds, 3^{rd} party clouds, and user device clouds. For example, the structure of one cloud, such as the RAN cloud, is repeated in the CN and 3^{rd} party clouds. In other words, there may be multiple groups of modules (e.g. services, C/M and infrastructure modules), each provided by a different cloud. Each group of modules, in each cloud, may be organized and interconnected in a same or similar manner, thus providing for the illustrated repeated structure.

According to various embodiments, user devices (e.g. wireless devices, UEs) can be provided using a cloud architecture. The components of this cloud architecture can all be located within a same physical device, or different components can be located in different physical devices. This cloud architecture can also be the same or similar to that of the other clouds, e.g. the RAN cloud. That is, the structure and interfaces within a device-cloud can be the same as for other types of clouds. In such embodiments, the multiple XaaS modules can be downloaded by different XaaS module owners into devices.

In various embodiments, unified interfaces can be applied to devices, RAN clouds, core network clouds, and other 3^{rd} party clouds to facilitate interoperation of various components of the entire multi-cloud system.

As illustrated, the RAN is associated with a single cloud. Alternatively, different components of the RAN can be provided, each associated with its own cloud. For example, a RAN may be implemented using a centralized unit (CU) and one or more distributed units (DU). Each CU and DU may be implemented using its own cloud. Each cloud may have a structure and architecture similar to that of the RAN cloud.

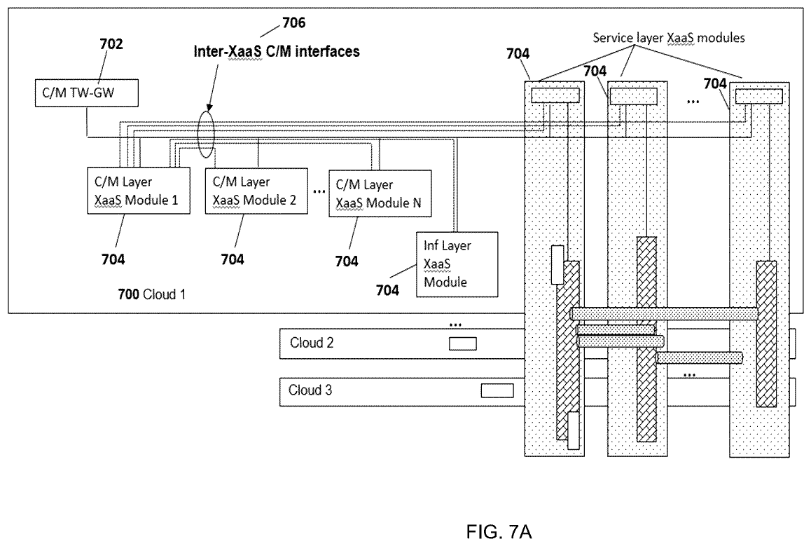

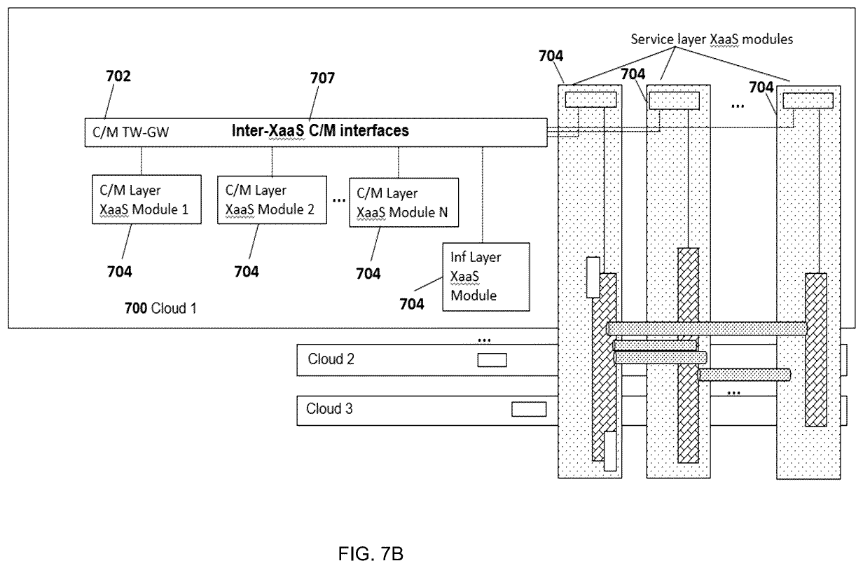

In various embodiments, as described with respect to FIGS. 7A and 7B, the inter-XaaS interfaces 290 of FIG. 2 are implemented in a particular manner potentially using a C/M TW-GW. The C/M TW-GW (or other similar C/M plane interface GW) may act as an intermediary or relay for coupling different XaaS C/M functions (C/M layer XaaS modules), different service layer XaaS modules, different infrastructure layer XaaS modules, or a combination thereof. The C/M TW-GW may be the C/M plane interface GW 402 of FIGS. 4A to 4C for example. The C/M TW-GW may be as in FIGS. 4D to 4G.

FIG. 7A illustrates C/M plane interfaces for a service based interface (SBI), according to an embodiment of the present disclosure. In this embodiment, the TW-GW acts as a signaling messages forwarding function. The forwarding may occur without translation of the signaling messages. Alternatively, the signal message forwarding function can include translation operations. As illustrated, all C/M functions connect with each other in a full mesh structure. The C/M TW-GW 702 receives signaling messages from each source XaaS module 704 and forwards such signaling messages to designated destination XaaS modules 704. Thus, the TW-GW acts as an intermediary for such signaling messages. This forwarding action produces the inter-XaaS C/M interfaces 706 illustrated using dotted lines. These interfaces may be direct logical interfaces as viewed by the XaaS modules. FIG. 7A shows one example in one cloud 700 (e.g., RAN cloud, CN cloud, or any other 3^{rd} party cloud). FIG. 7A shows the connections from C/M layer XaaS module 1 to other C/M layer, infrastructure layer and service layer XaaS modules for clarity purposes. As shown, the C/M Layer XaaS module 1 is directly (logically) connected to all other C/M layer XaaS modules, all infrastructure layer XaaS modules, and all service layer XaaS modules. All other C/M functions (modules) have similar structure and connections, although those connections are not shown in FIG. 7A.

FIG. 7B illustrates C/M plane interfaces for a service based interface (SBI), according to another embodiment of the present disclosure. In this embodiment, the TW-GW 702 acts as a signaling messages translator. That is, the C/M TW-GW 702 acts as an interface translator and isolates XaaS producers from XaaS consumers. It is also noted that, within a single cloud, one or multiple C/M TW-GWs may be provided. The C/M TW-GW receives signaling messages from each source XaaS module 704 (in C/M layer, infrastructure layer and service layer) and translates and forwards such signaling messages to designated destination XaaS modules (in C/M layer, infrastructure layer and service layer). Thus, the TW-GW again acts as an intermediary for such signaling messages. This forwarding action produces the inter-XaaS C/M interfaces 707 as illustrated and connected to the modules via dotted lines. FIG. 7B shows one example in one cloud 700 (e.g., RAN cloud, CN cloud, or any other 3^{rd} party cloud). This is similar to the configuration of FIGS. 4A-4C, with the C/M TW-GW (e.g. C/M plane interface GW) interconnecting the different Service and C/M XaaS modules, thus providing the inter-XaaS C/M interfaces, which may correspond to the interfaces 6G1. C/M-TW-GW may facilitate (potentially anonymous) interactions among XaaS services. The C/M-TW-GW may receive a signaling message from one XaaS service (consumer) for requesting a service, encrypt the message, find a provider of the requested service, and send a signaling message to this provider. The signaling message received by the C/M-TW-GW may be different from the signaling message sent by the C/M-TW-GW. That is, when a GW receive a request type of message, it does not necessarily simply forward the message to the selected target, Rather the GW may change the received message into another new request message with different message content.

Various embodiments of the present disclosure support multiple operation modes. Various embodiments enable or facilitate an open environment to allow multiple partners to jointly provide XaaS services. Partners may be providers of 6G system infrastructures and 3^{rd} parties that are neither customers, nor infrastructure providers. In various embodiments, each provider of XaaS services is defined as a role. The system allows flexible mapping between partners and roles of the 6G System. An infrastructure provider may presume all roles of the 6G System using its infrastructures including network infrastructure, data centers and storage infrastructures. An infrastructure provider may presume only some of roles and allow 3^{rd} parties provide other XaaS services. An infrastructure provider can provide infrastructure as a service, at the same time, the provider can be a vertical customer of the system. The flexible mapping between partners and roles enables the 6G System to adapt to a variety of 6G System operation modes to meet different business capability and interests.

According to various embodiments, modules providing a functionality as a service to other modules are a part of a communication network. As such, the modules include communication functionality, and utilize communication network infrastructure, in addition to providing other potential functionality such as data processing or data storage. A module providing functionality as a service may provide the entire functionality to its client(s) without the clients needing to perform further management tasks. Instead, the functionality is provided in response to request messages, for example. Modules providing a first service may rely on other modules providing other services, in order to deliver the first service, or in order to maintain its functioning, or the like. Modules may be interdependent on one another, for example in a closed system of interdependence, via the provision of services to one another.

In embodiments, the XaaS model facilitates network customization and reconfiguration. New modules can be added without reconfiguring existing modules. Networks can be deployed only with the required modules, and modules can be scaled up or down depending on requirements.

According to various embodiments, modules are provided at a certain level of granularity. This may be in addition to the modules being of three types: service modules, C/M modules, and infrastructure modules. The level of granularity is such that there are neither too many different modules (which would lead to high complexity) nor too few modules (which would lead to high generality of each module type). Accordingly, in various embodiment, each module is configured to provide one and only one overall general function as a service. This function is unique and completely provided by the module (with the module relying on other modules to provide services thereto as necessary). The module is thus self-contained from the perspective of clients which use the module to access the provided service.

According to embodiments, a service module (for example) includes all of the sub-components necessary for it to receive and respond to service requests (from clients) by performing a requested service. For example, the service module may include components in a service C/M plane and a service data plane, which together perform all of the required operations of the service module. The service data plane may include sub-modules (e.g. computer processor sub-modules, data storage modules, real-world interface modules, etc.) which perform various functionalities as required by the service module. The service data plane may further include interfaces or interconnections between such sub-modules.

In view of the above, embodiments of the present disclosure specify both inter-XaaS interfaces and intra-XaaS interfaces. These two types of interfaces may be separate from one another and may be distinct from one another in one or more ways. The inter-XaaS interfaces may be standardized while the intra-XaaS interfaces are not necessarily standardized. The interfaces may have a well-defined function and their structure and function may be independent of their deployment scenario. Thus, the interfaces may facilitate a modular design approach.

In some embodiments, the C/M plane interface gateway (GW) or trustworthy gateway (TW-GW) is configured to perform an authorization function, selection or lookup function, or the like. Thus, the C/M-GW or TW-GW may perform a selection function. The C/M-GW may be pre-configured to hold or access one or more authorization profiles that indicate which XaaS services are authorized to use which other XaaS services. In this way, after receiving a service request from an XaaS service, the C/M GW checks this authorization profile to determine another XaaS service that can provide the service specified in the request. The C/M-GW can then forward the request to such another XaaS service. The XaaS services may be infrastructure modules, service modules or C/M modules. Therefore, the C/M-GW may receive a request for a first module of the infrastructure modules, the service modules and the control and management modules to use a specified service. In response to the request, the C/M-GW may determine (e.g. by consulting a provided authorization profile) a second module of the infrastructure modules, the service modules and the control and management modules. The second module provides the specified service. Furthermore, (e.g. according to the authorization profile) the first module is authorized to receive the specified service from the second module. The C/M-GW may then initiate provision of the service, for example by forwarding the received request to the second module.

In some embodiments, the C/M plane interface gateway (GW) or trustworthy gateway (TW-GW), the data plane interface gateway (GW) or trustworthy gateway (TW-GW), or both, within a BAS domain, is configured and used to control access, by XaaS services, devices, or both, to the BAS domain. The above-described authorization function may be used for this purpose. Thus, the GWs or TW-GWs may be configured to perform access control based on predetermined authorization parameters, and identification or authentication may also be employed for this purpose. A GW or TW-GW may allow access to some or all resources in a BAS domain upon determining that the XaaS service or device is authorized to access such resources, and block access otherwise. The authorization may be pre-configured for example.

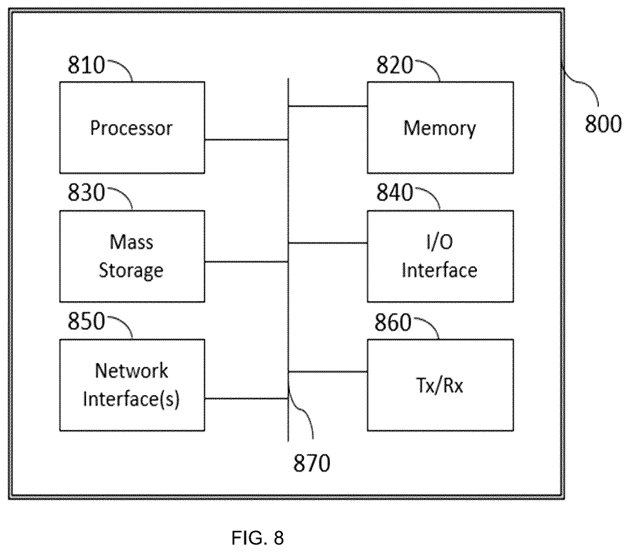

FIG. 8 is a schematic diagram of a computing device 800 that may perform any or all of operations of the methods and features explicitly or implicitly described herein, according to different embodiments of the present disclosure. For example, a computer equipped with network function may be configured as the computing device 800. One, two or more such computing devices may be coupled together in order to provide embodiments of the present disclosure. Multiple physically separate devices (e.g. in the same or separate datacenters) may be coupled together in order to provide one, two or more of such computing devices. When a device provides an infrastructure module, that device may consist primarily of an associated resource. For example, a computing module may consist primarily of computer processors, while a storage module may consist primarily of computer memory.

As shown, the device 800 may include a processor 810, such as a Central Processing Unit (CPU) or specialized processors such as a Graphics Processing Unit (GPU) or other such processor unit, memory 820, non-transitory mass storage 830, input-output interface 840, network interface 850, and a transceiver 860, all of which are communicatively coupled via bi-directional bus 870. According to certain embodiments, any or all of the depicted elements may be utilized, or only a subset of the elements. Further, device 800 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 820 may include any type of non-transitory memory such as static random access memory (SRAM), dynamic random access memory (DRAM), synchronous DRAM (SDRAM), read-only memory (ROM), any combination of such, or the like. The mass storage element 830 may include any type of non-transitory storage device, such as a solid state drive, hard disk drive, a magnetic disk drive, an optical disk drive, USB drive, or any computer program product configured to store data and machine executable program code. According to certain embodiments, the memory 820 or mass storage 830 may have recorded thereon statements and instructions executable by the processor 810 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the disclosure have been described herein for purposes of illustration, various modifications may be made without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the disclosure to provide a computer program product or program element, or a program storage or memory device such as a magnetic or optical wire, tape or disc, or the like, for storing signals readable by a machine, for controlling the operation of a computer according to the method of the disclosure and/or to structure some or all of its components in accordance with the system of the disclosure.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although the present disclosure and invention(s) associated therewith have been described with reference to specific features and embodiments, it is evident that various modifications and combinations can be made thereto without departing from such invention(s). The specification and drawings are, accordingly, to be regarded simply as an illustration of embodiments of the disclosure, for example as defined by the appended claims, and are contemplated to cover any and all modifications, variations, combinations or equivalents that fall within the scope of the present disclosure and its invention(s).

1. A system comprising:
one or more infrastructure modules each providing a respective infrastructure resource as service;
one or more service modules each providing a respective functionality as service and utilizing at least one of the infrastructure resources as service;
one or more control and management modules each providing a respective management or control resource as service, at least one of the control and management modules providing said respective management or control resource as service to at least one of the infrastructure modules or the service modules; and
one or more gateways providing a secured connection with, and facilitating interaction between, some or all of the infrastructure modules, the service modules and the control and management modules.

2. The system of claim 1, wherein some or all of the infrastructure modules, the service modules, the control and management modules, and the one or more gateways are implemented using virtualized resources provided by a plurality of clouds.

3. The system of claim 2, wherein the one or more gateways include a C/M plane interface gateway (GW) or trustworthy gateway (TW-GW) configured as an intermediary for interconnecting control and management functions of: the infrastructure modules, the service modules and the control and management modules residing in a same one of the clouds.

4. The system of claim 3, wherein the C/M plane interface GW or TW-GW is configured to control access to one or more of the infrastructure modules, the service modules and the control and management modules, by one or more other of infrastructure modules, the service modules and the control and management modules or by another device.

5. The system of claim 3, wherein said some or all of the infrastructure modules, the service modules and the control and management modules are implemented using virtualized resources in the plurality of clouds, the system further comprising, in each one of the plurality of clouds, a different respective one of the C/M plane interface gateways (GWs) or trustworthy gateways (TW-GWs), wherein different respective ones of the C/M plane interface gateways (GWs) or trustworthy gateways (TW-GWs) are coupled together for interconnecting different ones of the infrastructure modules, the service modules and the control and management modules residing in different ones of the clouds.

6. The system of claim 3, wherein the C/M plane interface gateway (GW) or trustworthy gateway (TW-GW) is configured to operate as a signal message forwarding function in order to facilitate an interface between one or more pairs of modules, each pair of modules selected from the one or more infrastructure modules, the one or more service modules, and the one or more control and management modules, the interface being a direct logical interface.

7. The system of claim 3, wherein the C/M plane interface gateway (GW) or trustworthy gateway (TW-GW) is configured to operate as a signal message translator in order to facilitate an interface between one or more pairs of modules, each pair of modules selected from the one or more infrastructure modules, the one or more service modules, and the one or more control and management modules, the signal message translator changing content of messages being forwarded between said one or more pairs of modules.

8. The system of claim 3, wherein the C/M plane interface gateway (GW) or trustworthy gateway (TW-GW) is further configured to communicatively couple some of all of the infrastructure modules, the service modules and the control and management modules to a C/M plane connection, the C/M plane connection operative for control plane messaging between client devices, servers, and some or all of the infrastructure modules, the service modules and the control and management modules.

9. The system of claim 3, wherein the C/M plane interface gateway (GW) or trustworthy gateway (TW-GW) is configured to:
receive a request for a first module of the infrastructure modules, the service modules and the control and management modules to use a specified service;
determine a second module of the infrastructure modules, the service modules and the control and management modules, the second module providing the specified service and the first module being authorized to receive the specified service from the second module; and
forward the request to the second module.

10. The system of claim 1, further comprising a data plane interface gateway (GW) or trustworthy gateway (TW-GW) configured as an intermediary for interconnecting data processing functions of some or all of the service modules to a data plane connection, the data plane connection operative for data transmission between client devices, servers, and some or all of the infrastructure modules, the service modules and the control and management modules.

11. The system of claim 10, wherein the data plane interface GW or TW-GW is configured to control access to one or more of the infrastructure modules, the service modules and the control and management modules, by one or more other of infrastructure modules, the service modules and the control and management modules or by another device.

12. The system of claim 10, wherein said some or all of the service modules are implemented in a plurality of clouds, the system further comprising, in each one of the plurality of clouds, a different respective one of the data plane interface gateways (GWs) or trustworthy gateways (TW-GWs), wherein different respective ones of the data plane interface gateways (GWs) or trustworthy gateways (TW-GWs) are coupled together for interconnecting different ones of the service modules residing in different ones of the clouds.

13. The system of claim 12, wherein one or more of the different respective ones of the data plane interface gateways (GWs) or trustworthy gateways (TW-GWs) are operative to provide a 6G data plane interconnecting one or more of the service modules with one or more client devices, said interconnecting using the data plane connection.

14. The system of claim 13, wherein the 6G data plane is instantiated in support of a mission involving said interconnected one or more of the service modules and requiring joint contribution from said one or more of the service modules.

15. The system of claim 1, wherein the infrastructure modules, the service modules and the control and management modules comprise a first group of modules implemented using virtualized resources provided by a first cloud and a second group of modules implemented using virtualized resources provided by a second cloud, and wherein the first group of modules are organized and interconnected in a same manner as the second group of modules.

16. The system of claim 1, further comprising:
a C/M plane interface gateway (GW) or trustworthy gateway (TW-GW) configured as an intermediary for interconnecting, via dedicated and secured connections, the infrastructure modules, the service modules and the control and management modules residing in a same one of a plurality of clouds;
a data plane interface GW or TW-GW configured as another intermediary for interconnecting, via further dedicated and secured connections, some or all of the service modules to a data plane connection, the data plane connection operative for data transmission between client devices, servers, and some or all of the infrastructure modules, the service modules and the control and management modules,
wherein the infrastructure modules, the service modules and the control and management modules, the C/M plane interface GW or TW-GW, and the data plane interface GW or TW-GW collectively form some or all of a basic architecture structure (BAS).

17. The system of claim 16, further comprising one or more additional BASs having a same structure as the BAS, the BAS and the additional BASs being interconnected.

18. The system of claim 16, further comprising:
another C/M plane interface gateway (GW) or trustworthy gateway (TW-GW) forming part of another BAS and connected to the C/M plane interface GW or TW-GW of the BAS; and
another data plane interface GW or TW-GW forming part of said other BAS and connected to the data plane interface GW or TW-GW of the BAS.

19. The system of claim 1, wherein the system serves at least one device which is configured to include:
one or more further infrastructure modules each providing a respective infrastructure resource as service;
one or more further service modules each providing a respective functionality as service and utilizing at least one of the infrastructure resources as service; and
one or more further control and management modules each providing a respective further management or control resource as service, at least one of the further control and management modules providing said respective further management or control resource as service to at least one of the further infrastructure modules or the further service modules.

20. A method comprising:
providing one or more infrastructure resources as service, using one or more respective infrastructure modules;
providing one or more functionalities as service, using one or more respective service modules, at least one service module utilizing at least one of the infrastructure resources as service;
providing one or more management or control resources as service using one or more respective control and management modules, at least one of the control and management modules providing said respective management or control resource as service to at least one of the infrastructure modules or the service modules; and
providing one or more gateways providing a secured connection with, and facilitating interaction between, some or all of the infrastructure modules, the service modules and the control and management modules.
